(19) United States
(12) Patent Application Publication
(10) Pub. No.: US 2011/0177973 A1
(43) Pub. Date: Jul. 21, 2011

(54) COMBINATORIAL SYNTHESIS AND USE OF LIBRARIES OF SHORT EXPRESSED NUCLEIC ACID SEQUENCES FOR THE ANALYSIS OF CELLULAR EVENTS

(75) Inventor: Moritz Rossner, Gottingen (DE)

(73) Assignee: Max-Planck-Gesellschaft zur Forderung der Wissenschaften e.V., Munchen (DE)

(21) Appl. No.: 13/120,616

(22) PCT Filed: Sep. 24, 2009
(86) PCT No.: PCT/EP2009/062384

§ 371 Date: Mar. 31, 2011

(30) Foreign Application Priority Data
Sep. 25, 2008 (EP) 08165151.5

(51) Int. Cl. C40B 30/06; C40B 40/02

(52) U.S. Cl. 506/10; 506/14

(57) ABSTRACT

The present invention is concerned with the provision of screening assays. More specifically it relates to a method to a method for determining whether an exogenous stimulus is capable of eliciting at least one biological response in a host cell comprising the steps of (i) applying the said stimulus to a host cell which comprises a plurality of different polynucleotide constructs each construct comprising a unique expressed tag (EXT) operatively linked to an expression control sequence whose activity can be exclusively modulated by one specific signalling pathway or cellular sensor implemented in said host cell, said signalling pathway or cellular sensor being involved in eliciting a biological response and being sensitive for the exogenous stimulus, (i) determining the amount of at least one expressed tag; and (iii) comparing the amount of the at least one unique expressed tag to a suitable reference amount, whereby it is determined whether the exogenous stimulus is capable of eliciting at least one biological response in the host cell.

The present invention is concerned with the provision of screening assays. More specifically it relates to a method for determining whether an exogenous stimulus is capable of eliciting at least one biological response in a host cell comprising the steps of (i) applying the said stimulus to a host cell which comprises a plurality of different polynucleotide constructs each construct comprising a unique expressed sequence tag (EXT) operatively linked to an expression control sequence whose activity can be exclusively modulated by one specific signalling pathway implemented in said host cell, said signalling pathway being involved in eliciting a biological response and being sensitive for the exogenous stimulus, (i) determining the amount of at least one expressed tag; and (iii) comparing the amount of the at least one unique EXT to a suitable reference amount, whereby it is determined whether the exogenous stimulus is capable of eliciting at least one biological response in the host cell.

To maintain homeostasis cells adapt continuously to changing environmental conditions. Genetic and/or environmental factors can lead to a progressive aberration of this adaptive behavior (Fishman and Porter, 2005). One example for such a process is the development of cancer. According to the current state of research cancer cells lose progressively diverse mechanisms that inhibit uncontrolled proliferation. The interaction of these processes, however, has not been properly understood (Araujo et al., 2007). Other examples comprise genetic complex and often chronic psychiatric disorders (Agid et al., 2007). In these cases silently progressing metabolic disorders are discussed as possible reasons. Diabetes has become a wide spread disease and is most likely caused by multiple and largely unknown genetic factors (Kitano et al., 2004).

The complex genetic disorders as well as the simple monogenic (mendelian) disorders have in common that the dynamic equilibrium of physiologic processes in the cell changes at a certain time. The findings of systems biology showed that the normal or pathologic behaviour of cells has to be understood in the context of the interaction of all cellular components (Friedman and Perrimon, 2007; Perrimon et al., 2007). Only an improved understanding of all cellular processes can lead to the development of new therapies and new pharmaceutical agents (Fishman and Porter, 2005).

Several high throughput methods can be used to analyze cellular functions (Chanda and Caldwell, 2003). The entirety of transcripts, i.e. those parts of the genome that are used for the synthesis of mRNA, is known as the “transcriptome”. It is far more dynamic and complex then envisaged a few years ago. The most advanced technologies for the high throughput ‘screening of the transcriptome are the “microarray” technologies (Chanda and Caldwell, 2003). They are based on the specific hybridization of nucleic acids in solution (targets) with complementary nucleic acids bound to a solid surface (probes) and allow the reliable analysis of almost the complete transcriptome. Alternatively, high throughput sequencing techniques may complement microarray approaches for globally scaled analyses of the genome and transcriptome in the near future (Shendure, 2008; Shendure et al., 2008).

The entirety of proteins is known as the “proteome”. Proteins are responsible for most cellular processes and they are the most frequent target molecules for pharmaceutical compounds (“drug targets”). The proteome can be analyzed by high throughput methods (Hultschig et al., 2006; Sauer et al., 2005). However, due to the biophysical properties of proteins these methods are laborious and the lack of amplification limits their sensitivity. In addition, proteins in living cells are modified in multiple, often still unknown ways. A simultaneous analysis of the complete proteome is currently impossible.

It has been known for a long time that the different molecules in the cell (DNA, RNA, proteins, lipids and low molecular metabolic products) interact in a variety of ways. The term “interactome” has been used so far almost exclusively for the protein-protein interactions in the cell (Cusick et al., 2005; Rual et al., 2005). For the analysis of these interactions biochemical and genetic methods are available (Cusick et al., 2005; Hultschig et al., 2006; Rual at al., 2005; Sauer et al., 2005). All biochemical methods have the disadvantage that the actual measurement has to be performed in vitro and can thus be biased by the extraction and solubilization methods. In addition, all biochemical methods are very time consuming. Genetic methods that are based on the direct or indirect activation of reporter genes have the advantage that they can in principle be applied in vivo. In some cell based assays, the measurement can be performed in the natural subcellular environment (“contextual specificity”) (Kerppola, 2006; Michnick et al., 2007). This is especially important for complex membrane bound receptor molecules that form the main group of drug targets. Rapid high throughput screening of protein-protein interactions can currently only be achieved in yeast cells by the technically limited and often incorrect yeast-two-hybrid assay or by using protein arrays with in vitro synthesized proteins (Koegl and Uetz, 2007; Rual et al., 2005).

The total interactome exceeds pure protein-protein interactions and comprises in a larger sense DNA-protein, RNA-protein and lipid-protein interaction. For the detection of these interactions biochemical and genetic methods are available that are based on the activation of a reporter gene. High throughput methods are mostly limited to yeast and to in vitro approaches. The yeast-two-hybrid assay and protein arrays are methods that enable a high throughput of samples but both systems do not offer contextual specificity (Koegl and Uetz, 2007; Rual et al., 2005; Sleno and Emili, 2008). The yeast-two-hybrid and complementary mammalian assays are limited because the interactions under investigations are measured as soluble nuclear proteins and, therefore, all protein interactions that naturally take place in other cellular organelles or structures are artificially targeted to the nucleus. Additionally, interactions of membrane proteins or those that depend on post-translational modifications are in most cases not accessible to this system. Likewise, protein arrays strictly depend on in vitro synthesized or purified proteins and can not be analyzed in their natural cellular context (Siena and Emili, 2008).

All high throughput methods described above have increased the number of identified drug targets (Chanda and Caldwell, 2003). At the same time the percentage of targets that could be used successfully in the later stages of drug development has decreased disproportionately (Hood and Perlmutter, 2004). The attempt to speed up the process of target validation by high throughput methods has failed. At the moment there is no method available that allows a rapid and integrated analysis of a high number of cellular functions. This hampers the assessment of desired (“on target”) and undesired (“off target”) effects of new pharmaceutical compounds and slows down the development process.

The available experimental methods can only show a part of the network of cellular functions in living cells (Butcher, 2005). To overcome this problem it is attempted to model the behaviour of whole cells with computer programs (Fisher and Henzinger, 2007). For the development of these models, usually static sets of isolated data about cellular behaviour are used. However, the principles of intracellular signalling are to a large extent unknown. Additionally, it is unclear whether the results of such calculations from one cell of one type can be transferred to other types. Thus, there is need for a parallel and integrated measurement of cellular functions.

The problem underlying the present invention could be seen as the provision of means and methods for the integrated and parallel recording of a plurality of cellular functions, in particular, in living cells. This problem is solved by the embodiments characterized in the claims and here below.

Accordingly, the present invention relates to a method for determining whether an exogenous stimulus is capable of eliciting at least one biological response in a host cell comprising the steps of:
a) applying the said stimulus to a host cell which comprises a plurality of different polynucleotide constructs each construct comprising (i) a unique expressed tag (EXT) operatively linked to (ii) an expression control sequence whose activity can be exclusively modulated by one specific signalling pathway or cellular sensor implemented in said host cell, said signalling pathway or cellular sensor being involved in eliciting a biological response and being sensitive for the exogenous stimulus;
b) determining the amount of at least one expressed tag (EXT); and
c) comparing the amount of the at least one unique expressed tag (EXT) to a suitable reference amount, whereby it is determined whether the exogenous stimulus is capable of eliciting at least one biological response in the host cell.

As used herein, the term “exogenous stimulus” refers to a biological, chemical or physical stimulus or a combination of such stimuli. Chemical compounds to be used as a stimulus are, preferably, small molecules, inorganic ions, peptides or nucleic aids (RNA or DNA). Biological stimuli are, preferably, conferred by prokaryotes, eukaryotic cells viruses and parts thereof. Physical stimuli, preferably, encompass exposure to high or low temperature, agitation of the medium, tension and radiation. In a preferred embodiment of the method of the present application said exogenous stimulus is a compound brought into contact with the said host cell.

The term “applying” means that the stimulus has to be used in such a way that it can exert its effect(s) on the host cell. In the case of chemical stimuli or biological stimuli this, preferably, means direct physical contact of the chemical compound or the biological agent with the cell. More preferably, the stimulus will be applied into the growth medium or into the gaseous phase above the medium. In the case of prokaryotes or eukaryotic cells, it preferably means allowing direct physical interaction of the stimulus and the cell. Also preferably, applying includes contacting the cell with the metabolic products of the biological stimulus. In the case of physical stimuli, such as heat exposure or radiation, the cells need to be exposed to the stimulus. This can be achieved, e.g., by applying radiation or heat to a cell culture comprising the host cells to be used in the method of the present invention.

The term “biological response” refers to the physiological reaction of a cell to a stimulus. Preferably, such a reaction is mediated or accompanied by changes of the gene expression on a transcriptional or translational level, by a rearrangement of the cytoskeleton, by changed properties of biological membranes, by increased or decreased degradation of specific proteins, by post-translational modifications, such as phosphorylation, myristilation, glycolsylation, acetylation, biotinylation or ubiquitination, of cellular proteins or by a combination of these mechanisms. Biological responses include, preferably, cell proliferation, cell death, cell stress, alteration of the cellular metabolism, cell migration, cellular differentiation, altered cellular signalling processes, alteration of cell membrane permeability, herbicide resistance, fungicide resistance, or pesticide resistance.

The person skilled in the art also knows how to determine such cellular responses. Cell proliferation may be measured, for example, by counting the cells under the microscope or in an automated cell counter. Cell death can, preferably, be determined by microscopic inspection of the cells, by analysis of DNA fragmentation or by measuring apoptotic markers, such as CD95, CD95L or Bcl2. An alteration of the cellular metabolism can be determined, for example, by a changed oxygen or nutrient consumption of the cells. Cell migration and differentiation can be observed microscopically, preferably aided by time lapse video captures. Changes in the permeability of cellular membranes can be determined by measuring the uptake of labelled compounds. Resistances against drugs, herbicides, fungicides and pesticides may be determined by challenging the cells with the substance in question and then determining cell proliferation or survival.

“At least one biological response” in the context of the present invention refers to one or more different responses. Preferably, it relates to at least one, at least 2, at least 5, at least 10, at least 20, or at least 40 different biological responses. The number of biological responses which can be investigated is, in fact, only limited by the number of available unique EXTs.

The term “host cell” in the context of this invention relates to a cell of a plant, animal, fungus, unicellular eukaryote or prokaryote that contains at least one, preferably at least two, also preferably at least five, more preferably at least ten, even more preferably at least 20 and most preferably at least 40 of the polynucleotide constructs described below.

A “polynucleotide construct” as referred to herein is a nucleic acid molecule comprising at least an expression control nucleic acid sequence operatively linked to a nucleic acid sequence encoding a unique expressed tag (EXT). Preferably, it may further comprise nucleic acid sequences that allow for propagation of the polynucleotide construct in proliferating cells. Such sequences may include origins of replication that are functional in the respective host cell. Also preferably, it may comprise further nucleic acid sequences encoding peptides that allow the identification of cells that contain the polynucleotide construct. Preferably, such peptides mediate resistance against toxic substances, allow growth in minimal media, allow for detection due to detectable tags or fluorescence or have enzymatic activity that can be detected by adding suitable substrates to the medium.

Transduction by bacteriophages or transformation with plasmids, cosmids or bacterial artificial chromosomes are preferred methods for introducing the polynucleotide construct into prokaryotic host cells. Eukaryotic host cells can, preferably, be transfected with the polynucleotide construct. Such a transfection can be transient if the polynucleotide construct is not integrated into the genome. In this case it will be lost during mitosis of dividing cells. A stable transfection can be achieved if the polynucleotide construct comprises the above described nucleic acid sequences for its maintenance in the cell. In the presence of a suitable selection pressure only those cells survive that contain the polynucleotide construct. Daughter cells of these cells only survive if they inherit the polynucleotide construct from the parent cell. The reliable inheritance of the polynucleotide construct, preferably, is secured by integration of the construct into the genome of the host cell.

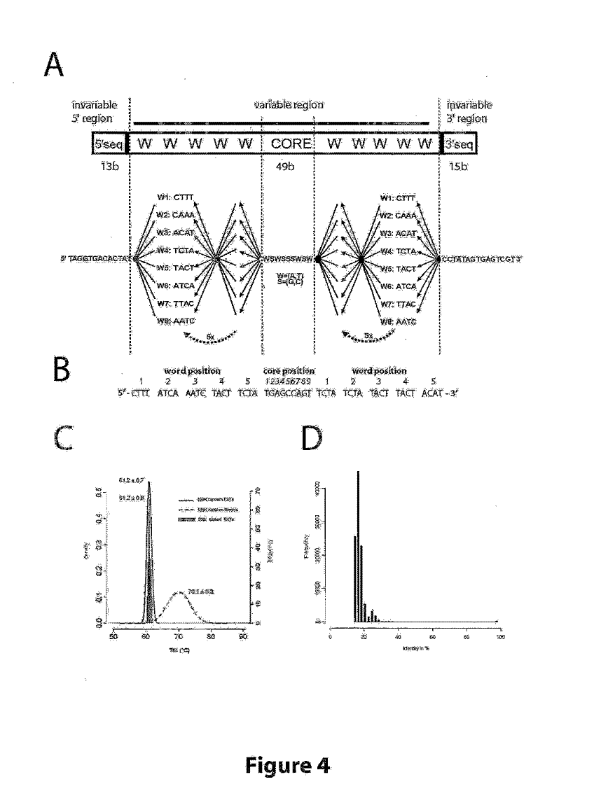

The term “unique expressed tag” (EXT) refers to a nucleic acid sequence that comprises three sequence parts. Defined nucleic acid sequences are located at the 5′-end and at the 3′-end of the EXT. These parts of the EXT enable the binding of specific primers so that the whole EXT can be amplified by the polymerase chain reaction (PCR). The specific part of the EXT is located between the defined sequences. The sequence of the specific part of one EXT differs from the sequences of the specific parts of all other EXTs in that it is unique, i.e. it differs by at least one base, preferably by at least two bases. The defined sequence parts are, preferably, identical for all EXTs. The person skilled in the art knows how to produce libraries of divergent nucleic acid sequences by combinatorial nucleic acid synthesis. The specific part of an EXT comprises between 10 and 100 nucleotides, preferably between 40 and 60 nucleotides. The availability of a particular EXT-construct within a cell is determined by DNA isolation and sequencing, quantitative RT-PCR, microarray analysis or any other method capable of detecting and quantifying nucleic acids. The expression of the EXT in the cell is determined on the transcriptional level by detection of its mRNA. Thus, it is not necessary that the nucleic acid sequence of the mRNA of an EXT can be translated into a peptide, i.e. the sequence may contain stop-codons. In a preferred embodiment of the invention the specific part of an EXT consists of a core of nine nucleotides that is flanked on both sides by five “words”, a design optimized to allow unbiased amplification and optimal performance for microarray analysis. Preferably, said words are assembled as taught in WO 00/20639, U.S. Pat. No. 7,393,665 or (Brenner et al., 2000). Each EXTs' specific part is comprised of a variable region of 49 base and invariable 5′ and 3′ attached defined sequences (depicted in FIG. 4a). The variable region consists of several words (W) flanking a core region. Eight different 4-nucleotide words are used, each comprised of 3 Adenosine (A)/Thymidine (T) residues and one Cytosine (C) residue (5′ CTTT 3′, 5′ CAAA 3′, 5′ ACAT 3′, 5′ TCTA 3′, 5′ TACT 3′, 5′ ATCA, 3′ 5′ TTAC 3′, 5′ AATC 3′) (Brenner et al., 2000). The core region comprises nine bases of alternating A,T (W) or G,C (S) residues with three central G,C (S) residues (FIG. 4a). The invariable 5′ (e.g. 5′ TAGGTGACACTAT 3′ SEQ ID NO: 1) and 3′ (e.g. 5′ CCTATAGTGAGTCGT 3′ SEQ ID NO: 2) located regions represent short sequence stretches of similar melting temperature. EXT oligonucleotide libraries can be generated with standard deoxy-nucleic-acid (DNA) oligonucleotide synthesis chemistry. Usually, the synthesis proceeds from the 3′ to the 5′ end. The synthesis of the EXT library presented herein was initiated with eight reactions and the 3′ invariable region attached to one of the eight different words. After the first synthesis cycle, the resins carrying the nucleotides were mixed and subsequently divided into eight equal portions to add the next eight words. The fifth cycle was extended with the core sequence followed by another five word cycles and the 5′ prime invariable portion (summarized in FIG. 4a). The number of biologically relevant cellular events likely exceeds the number of known interactions at the level of RNA-protein, DNA-protein, protein-protein and metabolite-protein among others by several orders of magnitude. Thus, the multiplexing capacity for EXT-based reporter assays (EXTassays) needs to be high and is determined by the combinatorial complexity of the EXT library and the discrimination power of the applied readout technology. The theoretical complexity of the 49 mer EXT library can be calculated as 8¹⁰ (10 positions with 8 words=word structure)×2⁹ (2 bases at 9 positions=core structure)=1,073,741,824×512=549,755,813,888≈5.5×10¹¹. Since some microarray platforms are restricted with respect to probe length, the combination of only 4 words (8⁴=4,096) and the core element (2⁹=512) leads to a theoretical complexity of 2,097,152≈2×10⁶. The central symmetrical core element increases the complexity compared to a pure word structure by approximately one order of magnitude. Moreover, the central and symmetrical structure allows monitoring the performance of each EXT with a few central mismatches and enhances and stabilizes the melting temperatures for hybridization approaches.

The meaning of the term “expression control nucleic acid sequence” refers to a nucleotide sequence that comprises promoter sequence motifs that allow for binding of an RNA-polymerase, preferably RNA polymerase I or II at the site of transcription initiation. Preferably, it may comprise additional binding sites for regulatory proteins that enhance or impede the transcription of the following DNA-sequence. Such proteins are, preferably, Gal4, LexA, TetR, Lacl, c-Myc, Jun-B, CREB, NF-kappa B or p53. The expression control sequence thus determines whether the DNA sequence downstream can be transcribed into RNA.

The term “plurality of different polynucleotide constructs” as used herein refers to at least two, preferably at least five, more preferably at least ten, even more preferably at least 20 and most preferably at least 40 different constructs in the same host cell, where each construct comprises a different EXT and a different expression control sequence.

The term “exclusively modulated” means that the transcription of the DNA-sequence linked to the respective expression control sequence compared to DNA-sequences linked to other expression control sequences is increased at least 2-fold; 5-fold; 10-fold; 50-fold; 100-fold; 500-fold; 1000-fold. The increase has to be statistically significant. Whether an increase is statistically significant can be determined without further ado by the person skilled in the art using various well known statistic evaluation tools, e.g., determination of confidence intervals, p-value determination, Student's t-test, Mann-Whitney test etc. Details are found in Dowdy and Wearden, Statistics for Research, John Wiley & Sons, New York 1983. Preferred confidence intervals are at least 90%, at least 95%, at least 97%, at least 98% or at least 99%. The p-values are, preferably, 0.1, 0.05, 0.01, 0.005, or 0.0001.

Methods for determining the amount of an EXT are known to the person skilled in the art. Preferably, the amount of DNA or RNA (targets) is determined by hybridization to a microarray (probes) directly by RNA/DNA- or RNA-RNA- or DNA/DNA-hybridization. Modified nucleotides can also be used either as targets or probes for hybridization. Also preferably, the mRNA serves as template for reverse transcription and the amount of the resulting DNA is determined by DNA/DNA-hybridization on a microarray. Preferably, the amount of DNA in the sample may be increased by PCR before hybridization. Preferably, the microarray referred to herein is a device that comprises a solid support, e.g. a small membrane, e.g., a nylon membrane, or glass slide, containing samples of various immobilized polynucleotides arranged in a regular pattern. The polynucleotides, preferably, correspond to the specific parts of the EXTs used in the respective experiment. Oligonucleotides to be used for microarrays preferably comprise from 5 to 50 nucleotides in length. A microarray works by exploiting the ability of a given mRNA-derived molecule (referred to as the ‘target’) to bind specifically to, or hybridize to, a DNA template (referred to as ‘probes’).

By using an array containing many probes, the expression levels of plethora (e.g., up to hundreds or thousands) of EXTs (the targets) within a cell, tissue or organ or within an organism can be determined, preferably in a single experiment, by measuring the amount of probes bound to each site on the array. With the aid of a suitable analyzer, such as an automatic reader device (e.g. a microarray scanner), the amount of e.g. fluorescently labelled targets bound to the spots on the microarray is precisely measured, generating a profile of the expression of EXTs in the cell. Moreover, PCR-based methods are amongst the preferred methods for determining the amount of one or several unique EXTs, quantitative real-time PCR is especially preferred. In principle, any method that allows the quantitative determination of nucleic acids may be employed.

The term “amount” as used herein encompasses the absolute amount of transcripts of an EXT, the relative amount or concentration of said transcripts of the EXT, such as numbers of transcripts per cell or per volume of cell culture, as well as any value or parameter which correlates thereto or can be derived there from. Such values or parameters comprise intensity signal values from all specific physical or chemical properties obtained from the said EXT-transcripts by direct measurements. Moreover, encompassed are all values or parameters which are obtained by indirect measurements specified elsewhere in this description, e.g., fluorescence intensities of fluorescently labelled transcripts. It is to be understood that values correlating to the aforementioned amounts or parameters can also be obtained by all standard mathematical operations.

A “reference amount” as referred to herein, is the amount of the unique expressed tag in a cell to which the exogenous stimulus has not been applied or that is unable to respond to the stimulus. Preferably, said inability is caused by an intervention on the genetic level, such as a gene knock out. Also preferably, the inability to respond to the exogenous stimulus is mediated by an inhibitory compound, such as a small molecule or a small interfering RNA. All other culture conditions of the cell that is used for the determination of the reference amount should be as similar as possible to the culture conditions of the stimulated cell. Also preferably, the reference amount can be the amount of one or more EXT-transcripts that is formed by a cell to which an exogenous stimulus known to elicit a certain biological response was added. In this case an amount of one or more EXT-transcripts in the experiment that is equal to the reference amount(s) indicates that the stimulus used in the experiment is also capable of eliciting said biological response.

The term “comparing” as used herein encompasses comparing the amount of the EXT-transcripts comprised by the first sample to be analyzed with an amount of the said same EXT-transcripts in the second sample. It is to be understood that comparing as used herein refers to a comparison of corresponding parameters or values, e.g., an absolute amount is compared to an absolute reference amount while a concentration is compared to a reference concentration or an intensity signal obtained from a test sample is compared to the same type of intensity signal of a reference sample. The comparison referred to in the method of the present invention may be carried out manually or computer assisted. A computer program may further evaluate the result of the comparison, i.e. automatically provide the desired assessment in a suitable output format. Based on the comparison of the aforementioned amounts, it is possible to assess whether an exogenous stimulus elicits a biological response or not. It is well known to the person skilled in the art that differences between experimental results depend on statistical variation. Thus, the determination whether an exogenous stimulus is capable of eliciting a biological response preferably includes testing whether the observed differences in two experiments are statistically significant. This can be determined without further ado by the person skilled in the art using various well known statistic evaluation tools recited elsewhere in this specification.

In another preferred embodiment of the method of the present invention the reference amount is the amount which can be determined in a host cell as described in step a) to which no exogenous stimulus has been applied. Preferably, an amount of the at least one unique expressed tag which differs from the reference amount is indicative for a stimulus being capable of eliciting at least on biological response.

In another embodiment of the method of the present invention the reference amount is the amount which can be determined in a host cell as described in step (a) to which an exogenous stimulus known to elicit at least one biological response has been applied.

In another preferred embodiment of the method of the present invention an amount of the at least one unique expressed tag which is essentially identical to the reference amount is indicative for a stimulus being capable of eliciting at least one biological response.

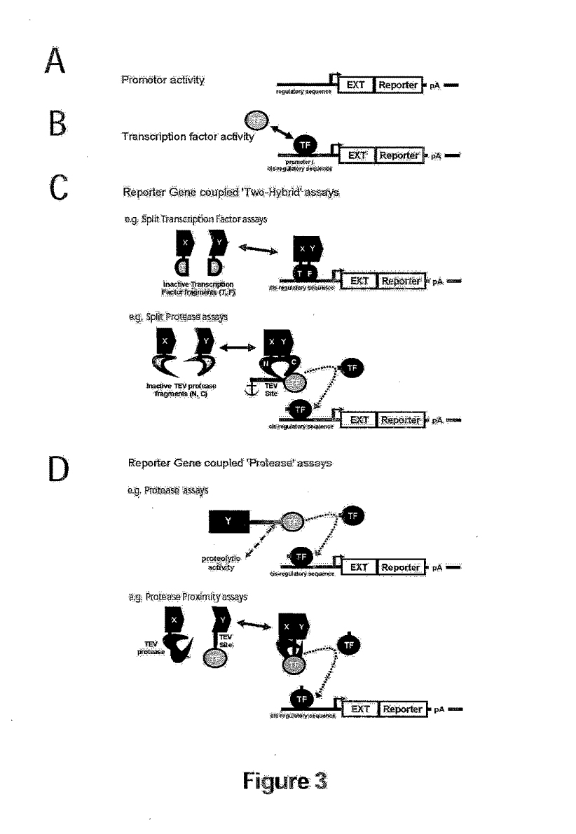

In another preferred embodiment of the method of the present invention said specific signalling pathway or cellular sensor comprises at least one exogenously supplied signalling component. These can be monitored with two-hybrid systems or any other reporter gene coupled systems to monitor for protein interactions or cellular events (Gisler et al., 2008; Suter et al., 2008). These include, preferably, the Split-TEV, Full-TEV (WO93/076932, Barnea et al., 2008; Wehr et al., 2006; Wehr et al., 2008) the Split-Ubiquitin (Dunnwald et al., 1999; Johnsson and Varshaysky, 1994a, b; Levy et al., 1996; Stagljar et al., 1998), the MAPPIT (Eyckerman et al., 2001; Lemmens et al., 2003) and Reverse MAPPIT (Eyckerman et al., 2005; Lemmens et al., 2006) approaches as well as Split-Intein techniques (Ozawa et al., 2001) or split-recombinase assays (Jullien et al., 2007; Jullien et al., 2003). EXTassays can be used to monitor for proteolytic activities (Protease assays) whereby a transcription factor is fused to a substrate protein and thereby inactivated (see also FIG. 3d).

A “specific signalling pathway” starts with the activation of a protein that functions as a receptor by the exogenous stimulus or an alteration in the cellular physiology caused thereby. Preferably, the receptor is activated by the binding of a peptide, a small molecule, an inorganic ion or a nucleic acid. Also preferably, the receptor is activated by a physical stimulus. Activation of a protein, preferably, means binding of this protein with one or more other proteins, proteolytic activation or inactivation of the target protein, post-translational modification of the target protein or a combination thereof. The activated receptor then activates further proteins by the said mechanisms which, again, may also activate further proteins. At the end of such a molecular cascade proteins become activated which confer the physiological changes to the cells that can be observed as biological response.

In the same manner, a “cellular sensor' can be applied in the method of the present invention. A “cellular sensor” as referred to herein is a genetically encoded cellular molecule, i.e. a peptide or polypeptide, which is capable of recognizing a cellular event. Such a cellular sensor, preferably, is changed in structure or function after a stimulus specific for the said sensor has been recognized.

Advantageously, by using combinatorial nucleic acid synthesis for the generation of unique EXTs, the method of the present invention allows for determining biological responses elicited by exogenous stimuli based on the alteration of the amount of the EXTs. It is to be understood that various biological responses will be determined in parallel (i.e. by one experimental set up) due to the allocation of specific EXTs to specific signalling pathways or cellular sensors for cellular events known to elicit certain biological responses. Thus, the cumbersome establishing of individual experimental set ups for measuring biological responses separately will be avoided. The combined use of defined cellular sensors with scalable sequence-tag based reporter systems to quantitatively measure a plurality of defined cellular events simultaneously has not been described before. So far, sequence tags have been proposed as reporter for promoter activation cDNA library screens (U.S. Pat. No. 7,026,123) and have been used in multiplexed yeast deletion strain survival assays (Shoemaker et al., 1996; Winzeler et al., 1999) and siRNA mediated lethality/survival screens in human cells (Schlabach et al., 2008; Silva et al., 2008). In a study the generation of a library of 240,000 DNA barcode probes based on empirical rules was described. According to the method of the present invention, however, a theoretical complexity of 2×10⁶ different probes can be reached.

The term “exogenously supplied signalling component” refers to one peptide, small molecule, inorganic ion or nucleic acid that is a part of the above described signalling pathway. Preferably such a protein or molecule is added to the medium so that the cell can take it up. In the case of a peptide it is also preferred to introduce a polynucleotide encoding the peptide operatively linked to an active expression control sequence into the host cell. If the exogenously supplied signalling compound is a peptide, it is preferred that said peptide contains a tag that allows for the identification of its interactions with other parts of the specific signalling pathway.

In another preferred embodiment of the method of the present invention, said at least one exogenously supplied signalling component or cellular sensor is capable of specifically interacting with at least one endogenous component of the said specific signalling pathway.

The term “specifically interacting” in the context of the present invention relates to the ability of the exogenous component(s) to bind to the endogenous target component(s) with higher affinity as compared to non-target components. In the context of the present invention binding of exogenous and endogenous components is specific if a target component is bound with statistically significant increased affinity, more preferably, an affinity being at least 2-fold, at least 5-fold, at least 10-fold, at least 50-fold, at least 100-fold, at least 500-fold, at least 1000-fold higher than the affinity a non-target component. The components can bind to each other either non-covalently, e.g. by hydrogen-bonds or hydrophobic interactions or they can bind covalently. The binding of two or more components of the signalling pathway preferably leads to a modification of the target component or components including but not limited to phosphorylation, glycosylation, acetylation, methylation or biotinylation. Preferably, the specific interaction can be detected by directly or indirectly detecting said modification. Direct detection methods, preferably, include mass spectometry, immunological methods or electrophoretic methods. Indirect detection methods are, preferably, based on the changed activity of the modified component.

The most important genetic method for the analysis of protein-protein interactions are currently the yeast and mammalian two-hybrid methods (Koegi and Uetz, 2007; Suter et al., 2008). In the context of the present invention it is one preferred method for the detection of protein-protein interactions. It is based on the principle that most eukaryotic transcription factors consist of two domains, a DNA-binding domain and an activation domain. These two domains have to be in close proximity to each other to initiate transcription. However, it is not necessary that they are part of the same molecule. In the yeast two-hybrid method the transcription factor, usually GAL4, is thus divided into two separate proteins, each of them containing one of the said domains. The first of the proteins, the so called “bait”, whose interaction is to be tested is then linked to the separated DNA-binding domain, the other protein, the so called “prey”, is linked to the activation domain. If the tested proteins bind to each other under the conditions present in the cell nucleus of yeast, the transcription of a reporter gene, e.g. lacZ, is enabled by the combined parts of the transcription factor. The expression of the reporter gene can then be detected, e.g. by the enzymatic production of a dye.

In the one-hybrid variant of this system the DNA-binding capabilities of a protein are determined (Vidal and Legrain, 1999). For this purpose the DNA-binding domain of the one protein is chosen from a library while the rest of the first protein as well as the activator protein remain unchanged. Thus, it is possible to test the binding of different DNA-binding domains to a specific DNA sequence.

The three-hybrid variant of this system enables the assessment of the RNA-binding capabilities of two proteins (Drees, 1999; Vidal and Legrain, 1999). The tested fusion-proteins do not interact not directly with each other, but bind to a certain RNA-sequence that serves as linker between the two fusion-proteins. In a preferred embodiment of the present invention an EXT is used instead of a conventional reporter gene.

The most important drawbacks of all transcription factor based two-hybrid methods are their inability to analyse protein-protein interactions outside the nucleus and thus the lack of contextual specificity for most proteins. In many cases, weak or transient interactions also remain undetected.

Another preferred method for the detection of protein-protein interactions in the context of the present invention is a split-protease assay (WO93/076932, Wehr et al., 2006; Wehr et al., 2008). A protease suitable for this method can be split into two peptides that are inactive on their own but can be activated by transcomplementation if they are brought into close proximity to each other. For the assay each of the protease domains is fused to one of the proteins whose interaction is to be tested. The cell has to be transfected with a polynucleotide construct that comprises both DNA-sequences encoding both fusion proteins each of them operationally linked to a functional promoter-sequence. If the proteins bind to each other, they bring the two protease domains together and thus restore the enzymatic activity. The reconstituted protease-activity is then used for the increased generation of a reporter protein.

In a preferred embodiment of this invention, the protease of Tobacco Etch Virus (TEV-protease) is used (WO93/076932, Wehr et al., 2006; Wehr et al., 2008). TEV-protease has the advantage that the protein can be split at several positions without compromising the ability of the separated proteins to be activated by transcomplementation.

In another preferred embodiment of the present invention, the split-protease fragments cleave an inactivated transcription factor. In this case the nucleotide sequence of the reporter gene is operationally linked to a promoter sequence that is modulated by said transcription factor. Transcomplementation of the protease leads to the liberation of the transcription factor. The free transcription factor can transiocate into the cell nucleus and act on the promoter sequence of the reporter gene. In a more preferred embodiment of the above described method an EXT is used instead of a conventional reporter gene.

In the context of this invention an “endogenous component” can be a peptide, a nucleic acid (DNA or RNA), a lipid or a small molecule. It may also be a complex that comprises at least two of the said compounds.

The term “transcription factor” is known to the person skilled in the art. It relates to a protein that is capable to increase or decrease the transcription of a gene by binding to the expression control sequence of the gene or to the RNA-polymerase complex.

The term “modulating the activity” refers to the ability of a transcription factor to increase or to decrease the transcription of the gene whose expression is controlled by this transcription factor in a statistically significant manner.

In another preferred embodiment of the method of the present invention the said at least one exogenously supplied signalling component is a transcription factor which is capable of modulating the activity of the said expression control sequence.

Furthermore, the present invention relates to a host cell comprising a plurality of different polynucleotide constructs, each construct comprising (i) a unique expressed tag operatively linked to (ii) an expression control sequence whose activity can be exclusively modulated by one specific signalling pathway or cellular sensor implemented in the said host cell, said signalling pathway or cellular sensor being involved in eliciting a biological response and being sensitive for an exogenous stimulus.

In a preferred embodiment of the host cell claimed in the present invention said specific signalling pathway or cellular sensor comprises at least one exogenously supplied signalling component.

In a preferred embodiment of the host cell of the present invention said at least one exogenously supplied signalling component or cellular sensor is capable of specifically interacting with at least one endogenous component of the said specific signalling pathway.

In a preferred embodiment of the host cell of the present invention, the said at least one exogenously supplied signalling component is a transcription factor which is capable of modulating the activity of the said expression control sequence.

In a preferred embodiment of the method of the present invention, the host cell described above is used for determining whether an exogenous stimulus is capable of eliciting a biological response in the said host cell.

In a preferred embodiment of the method of the present invention, the host cell is used as described above wherein said exogenous stimulus is a compound brought into contact with the said host cell.

In a preferred embodiment of the method of the present invention, the host cell is used as described above wherein the said at least one biological response is selected from the group consisting of: cell proliferation or differentiation, cell death, alteration of the cellular metabolism, cell migration, alteration of cell-permeability, drug resistance, herbicide resistance, fungicide resistance, and pesticide resistance. Finally, the present invention relates to a kit adopted for carrying out the method as described above comprising the host cell as described above.

The term “kit” as used herein refers to a collection of the aforementioned compounds, means or reagents of the present invention which may or may not be packaged together. The components of the kit may be comprised by separate vials (i.e. as a kit of separate parts) or provided in a single vial. Moreover, it is to be understood that the kit of the present invention is to be used for practising the methods referred to herein above. It is, preferably, envisaged that all components are provided in a ready-to-use manner for practising the methods referred to above. Further, the kit preferably contains instructions for carrying out the said methods. The instructions can be provided by a users manual in paper- or electronic form. For example, the manual may comprise instructions for interpreting the results obtained when carrying out the aforementioned methods using the kit of the present invention.

All the documents cited in this application are hereby incorporated by reference with respect to their specific disclosure content referred to above and in their entireties.

The figures show:

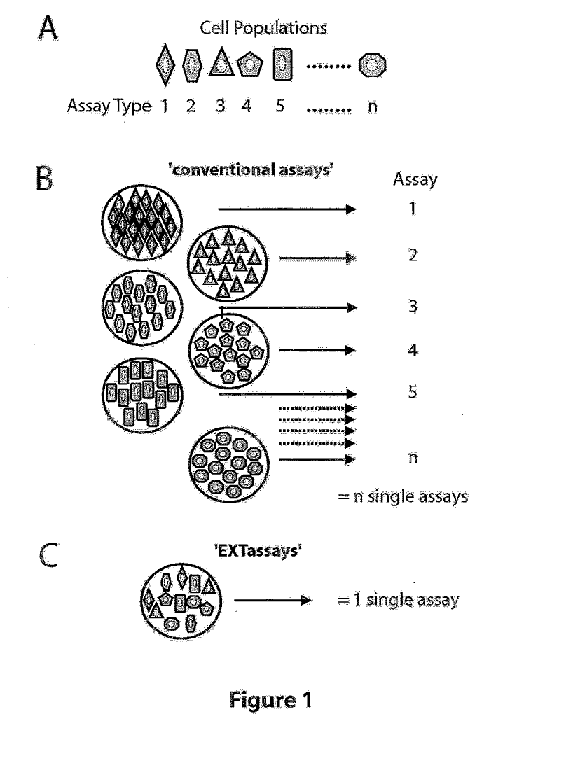

FIG. 1 depicts the general principle of conventional cell-based reporter assay formats and multiplexed EXTassays.
(A) Depicted are 1-n different cell populations and each population represents one distinct assay type. The assay components may be stably integrated into the genome of the host cell or may be transiently introduced by transfection or a combination of both strategies. The cell populations may represent a mixture of distinct assays in one cell type or one assay type in different cell types or multiple assay types in different cell types. The cell populations may also represent a mixture of single or multiple assays representing sub-populations that have been treated with a defined or multiple stimuli. These treatments or stimuli may represent the addition of substances or mixtures of substances of lower or higher molecular weight such as proteins, peptides or small molecular entities.
(B) In conventional reporter assays, each cell population represents a single assay that has to be analyzed separately. 1-n assays require 1-n single measurements.
(C) With EXTassays, 1-n assays can be simultaneously analyzed. 1-n assays require a single multiplexed measurement.

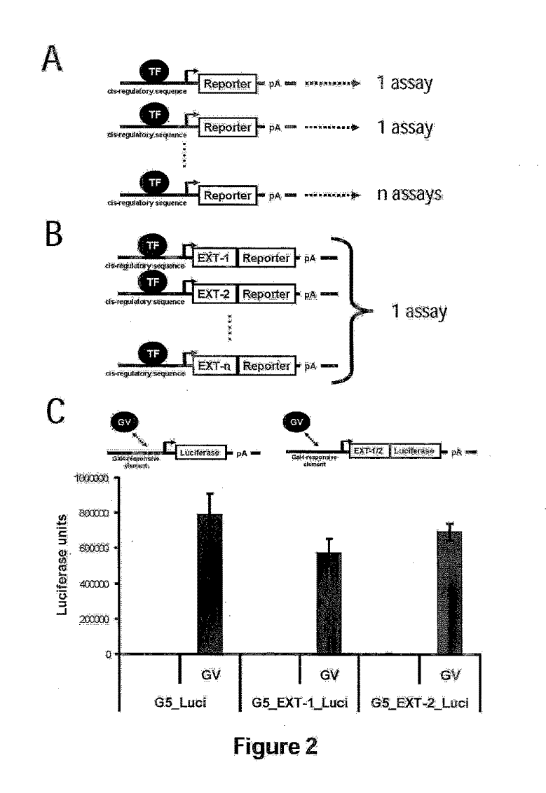

FIG. 2 depicts the general principle of conventional cell-based reporter assay formats and the reporter format of EXTassays.
(A) Depicted are the components of conventional reporter gene assays. A transcription factor (TF) or a combination of transcription factors regulates via a defined cis- and/or promoter sequence(s) the transcription of a reporter gene cloned downstream of the transcriptional start site that is depicted by the arrow and fused to a sequence stretch acting as poly-adenylation signal (pA). For all assays, the same reporter construct is used which requires 1-n different measurement to analyze 1-n reporter assays.
(B) In the EXTassay approach, multiple unique EXpressed Tags (EXTs 1-n) are added to the reporter constructs replacing or complementing the conventional reporter gene. Because all EXTs can be analyzed simultaneously, only 1 assay is required to monitor 1-n assays.
(C) The Luciferase based reporter gene assay in PC12 cells compares the performance of conventional and EXT containing reporter. The synthetic transcription factor comprising the DNA binding domain from Gal4 and the transactivation domain from the Herpes Simplex protein VP16 (GV) was co-transfected with a conventional Gal4-dependent reporter gene driving the expression of firefly luciferase (G5_Luci) or with corresponding luciferase reporter constructs containing EXTs (G5_EXT-1_Luci and G5_EXT-2_Luci). The conventional and EXT containing reporter constructs display several hundred-fold GV-dependent activation measured with luciferase. The additional EXT stretch does not interfere with reporter gene assays.

FIG. 3 depicts selected formats of reporter gene assays that can be integrated into EXTassays. Principally, any reporter gene based assay format can be applied.
(A) Any sequence regulating transcriptional activation or repression can be analyzed with EXT reporters. The regulatory sequence may represent different promoter or enhancer elements found 5′ or 3′ of the reporter gene or may be an integral part of the reporter. The regulatory elements may also include intronic elements or other elements modifying the abundance of corresponding mRNAs.
(B) EXTassays can be used to monitor for the constitutive or regulated activity of transcription factors or proteins that modulate the activity of transcription factors (co-activators and co-repressors) or substances or proteins that modify transcription factor activities which may result in altered post-translational modifications such as phosphorylation, acylation, acetylation, methylation, ubiquitination, sumoylation or combinations of these or other modifications. These modifications may result in altered DNA binding activities or in modified transcriptional capabilities, e.g. mediated by altered protein interactions.
(C) EXTassays can be used to monitor for protein-protein interactions. For example, split-transcription factor (TF) and/or reporter gene coupled split-protease systems can be integrated. With split-TF systems (the prototypical 2-hybrid systems), fusion constructs of inactive fragments of a transcription factor (usually the DNA binding domain separated from the transactivation domain, depicted as T and F) are fused to potentially interacting protein domains (depicted as X and Y). Upon interaction, the transcription factor becomes functional and activates reporter gene transcription. This system is limited to interactions of soluble proteins and interactions that are stable and/or occur in the nucleus of cells. In split-protease systems, inactive protease fragments (depicted as N and C) are fused to potentially interacting protein domains (depicted as X and Y). Upon interaction, proteolytic activity is reconstituted and e.g. an inactivated transcription factor (TF) is released from an anchor, can translocate to the nucleus and activate reporter gene transcription. These systems are particularly suited to monitor protein interactions that occur in the cytosol and at the membrane of cells. These or similar assays may be used to monitor for substances or proteins that modify proteolytic events or protein interactions directly or indirectly and which may be regulated by post-translational modifications such as phosphorylation, acylation, acetylation, methylation, ubiquitination, sumoylation or combinations of these or other modifications.
(D) EXTassays can be used to monitor for proteolytic activities (Protease assays) whereby a transcription factor is fused to a substrate protein and thereby inactivated. The proteolytic activity may be cell-intrinsic or exogenously added. EXTassays can be used to monitor for constitutive or regulated protein interactions monitored with ‘Protease Proximity assays'. These or similar assays may be used to monitor for substances or proteins that modify proteolytic events or protein interactions directly or indirectly and which may be regulated by post-translational modifications such as phosphorylation, acylation, acetylation, methylation, ubiquitination, sumoylation or combinations of these or other modifications.

FIG. 4 depicts the structure and properties of the EXpressed Tags (EXTs).
(A) Each EXT is comprised of a variable region of 49 bases and 5′ and 3′ attached invariable sequences. The variable region consists of several words (W) flanking a core region. Eight different 4-nucleotide words are used, each comprised of 3 Adenosine (A)/Thymidine (T) residues and one Cytosine (C) residue (5′ CTTT 3′, 5′ CAAA 3′, 5′ ACAT 3′, 5′ TCTA 3′, 5′ TACT 3′, 5′ ATCA, 3′ 5′ TTAC 3′, 5′ AATC 3′). The core region comprises nine bases of alternating A,T (W) or G,C (S) residues with three centrals G,C (5) residues. The invariable 5′ (5′ TAGGTGACACTAT 3′ SEQ ID NO: 1) and 3′ (5′ CCTATAGTGAGTCGT 3′ SEQ ID NO: 2) prime located regions represent short sequence stretches of similar melting temperature. The complex EXT oligonucleotide library was generated with standard deoxy-nucleic-acid (DNA) oligonucleotide synthesis chemistry procedures. The synthesis proceeds from the 3′ to the 5′ end. The synthesis was initiated with eight reactions and the 3′ invariable region attached to one of the eight different words. After the first synthesis cycle, the resins carrying the nucleotides were mixed and subsequently divided into eight equal portions to add the next eight words. The fifth cycle was extended with the core sequence followed by another five word cycles and the 5′ prime invariable portion. The theoretical complexity of the 49 mer EXT library can be calculated as 8¹⁰ (10 positions with 8 words=word structure)×2⁹ (2 bases at 9 positions=core structure)=1073741824×512=549755813888≈5.5×10¹¹.
(B) Depicted is the sequence of one sample EXT to illustrate the naming of the corresponding functional elements. The word positions 1-10 are numbered from 5′ to 3′ as well as the nucleotides in the core regions (core positions 1-9).
(C) Melting temperature analysis of EXTs was performed comparing virtual and cloned EXT libraries with randomized 49 mer sequence libraries. For the virtual libraries, 10⁵ different EXT- or 49-N-mers (comprising all four nucleotides in a randomized order) were computed and TMs were compared with a library of 229 cloned and sequenced EXTs. The virtual and cloned EXTs display a highly narrow average TM of 61.2±0.7 and 61.2±0.8, respectively, in contrast to the broadened distribution of the random 49-Nmers with an average TM of 70.1±3.3.
(D) Similarity scores of the cloned EXT libraries. Pairwise BLAST analyses of each EXT versus all EXTs in the library were performed for all library members against each other and the identity scores were plotted. The cloned EXT library displays a low average similarity sore below 20% and indicates a high overall complexity.

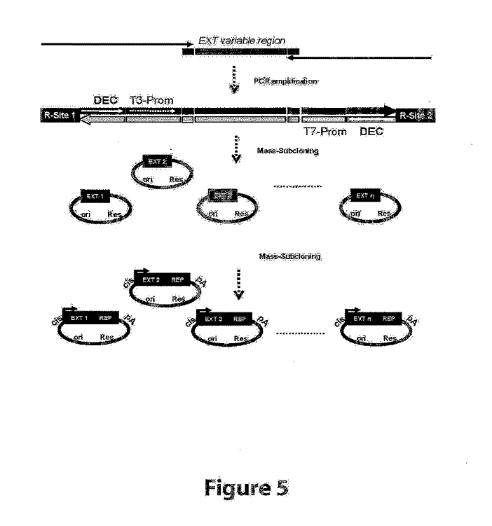

FIG. 5 depicts the amplification and subcloning strategy of EXTs. The EXT oligonucleotide library can be PCR amplified using two primers with complementary sequences directed against the invariable region of the EXTs. The primers may also include additional sequences such as a T3/T7 minimal RNA polymerase promoter stretches, decoder sequences (DEC) and sites for either restriction-enzyme or recombinase mediated subcloning (R-site 1, R-site 2). Recombination sites may be selected to be compatible with e.g. the Gateway system (for detailed descriptions see www.invitrogen.com), In-Fusion, Creator systems (for detailed descriptions see www.clontech.com), the StarGate system (for detailed descriptions see www.iba-go.com) or the MAGIC system (Li and Elledge, 2005). The resulting PCR products can be mass-subloned and amplified in E. coli with standard molecular biological techniques. The subcloning procedure may include shuttle plasmids that only carry genetic elements for amplification in E. coli (origin of replication, ori; resistance conferring gene, Res) or may directly yield expression plasmids carrying EXTs an additionally elements such as regulatory sequences (cis), a reporter-protein encoding element (REP) and poly-adenylation element (pA).

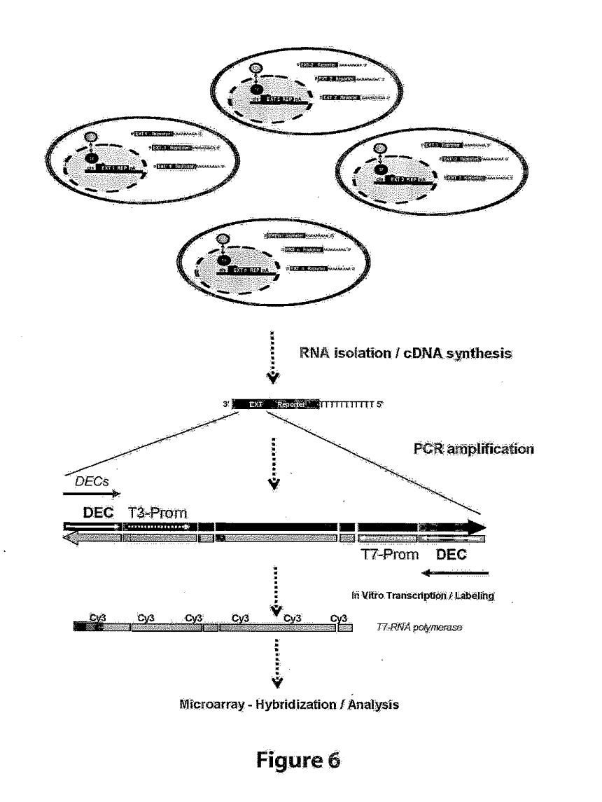

FIG. 6 depicts the principle of the expression strategy of EXTassays.

Pooled cell populations that carry one or more defined EXT reporter including all genetic components that ultimately lead to the activation of a or more transcription factors (TF) are analyzed simultaneously. Replicate pools may have been treated with a substance or different conditions which may alter the expression of EXTs. The pools of cells will be lysed at appropriate time points and genomic DNA (or plasmid DNA when transiently transfected cells are under investigation) and total RNAs or mRNAs will be prepared with standard techniques. DNA (not shown) or cDNA obtained via reverse transcription from total RNA or mRNA serves as input for PCR amplification with decoder primers directed against the DEC sequence stretch (DECs and DECas). The cDNA derived PCR product represents a complex mixture of differentially expressed EXT reporter in the various cell pools; whereas the DNA derived PCR products represent the input mixture of EXT constructs used for normalization. The PCR products (=targets) can be analyzed by qRT-PCR, Northern Blotting, sequencing or any other method that allows the quantitative assessment of nucleic acids. In a preferred application, the PCR products can be labelled by direct or indirect incorporation of fluorescent dyes e.g. via in vitro transcription (IVT) mediated by either T7 or T3 RNA polymerases. Direct labelling refers to incorporation of fluorescent nucleotides (such as Cy3- or Cy5 conjugated Uridine-Tri-Phopshate (UTP)); indirect labelling refers to incorporation of modified nucleotides (such as amnio-allyl-UTP) which allow for a secondary conjugation of dyes (such as Cy3- or Cy5). The labelled products (targets) can subsequently be analyzed with DNA microarrays (probes) that carry EXT complementary oligonucleotides at defined positions/spots. The relative fluorescent intensity of each spot can be used as a measure of the relative abundance or expression level of a given EXT in the corresponding target population.

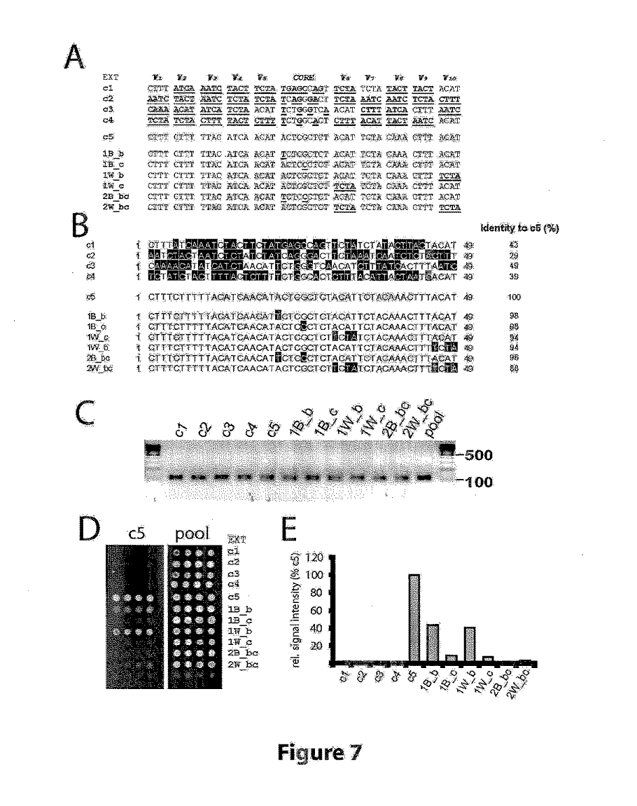

FIG. 7 depicts experiments controlling for the specificity and discrimination of EXTs in microarray hybridizations.
(A,B) Depicted are the sequences of five randomly picked EXTs (c1-c5) and oligonucleotides highly similar to the c5 EXT sequence used to assess the specificity and degree of cross-hybridization in microarray hybridizations. (A) Alignment plotted according to the word/core structure of the EXTs; words and bases in the core region that deviate from the sequence of c5 are bold and underlined. The specificity controls deviate only slightly from c5: 1B-b, with one base pair mismatch at the boundary of the core region; 1B_c, with one base pair mismatch at the centre of the core region; 1W_b, with one word mismatch at the very 3′ end of c5; 1W_c, with one word mismatch in close proximity 3′ to the core region. 2B-bc, with two base pair mismatches at the boundary and in the centre of the core region; 2W-bc, with two word mismatches at the 3′ boundary and 3′ end of the core region. (B) Alignment of the control EXTs to determine the overall base identities compared to c5. The identities in percent of all control EXTs versus c5 are given as: C1, 43%; C2, 29%; C3, 49%; C4, 39%; c5, 100%; 1B-b, 98%; 1B-c, 98%; 1W-b, 94%; 1W-c, 94%; 2B-bc, 96%; 2W-bc, 88%.
(C) c1-c5, control EXTs and a pool were separately PCR amplified with DECs and DECas primers and analyzed by agarose gel electrophoresis. The c5 and pooled PCR products were subsequently labelled by T7-RNA Polymerase mediated IVT (generating anti-sense products) with Cy3 and Cy5 dyes, respectively, and subjected to two-colour microarray hybridization.
(D) Representative, grey-scaled images corresponding to the Cy3 (left, c5) and Cy5 (right, pool) channels. The Cy5 stained pool sample shows strong signals at regions where complementary sense 5′ amino-labelled linear probes were spotted in quadruplicate. In contrast, the Cy3 signal (where only EXT c5 was labelled) shows strong signals only at the corresponding c5 spot and weaker signals at the single base (1B_b) and single word (1W_b) mismatch spots.
(E) The quadruplicate spot signal intensity shown in E are depicted as relative signal intensities in percent with the c5 signal set to 100%. The single base (1B_b) and single word (1W_b) boundary mismatches display approximately 40% and the single base (1B_c) and single word (1W_c) centre mismatches display less than 10% of the c5 signal. The double base (2B_c) and single word (2W_c) mismatches and the EXTs c1, c2, c3 and c4 show signals close to background.

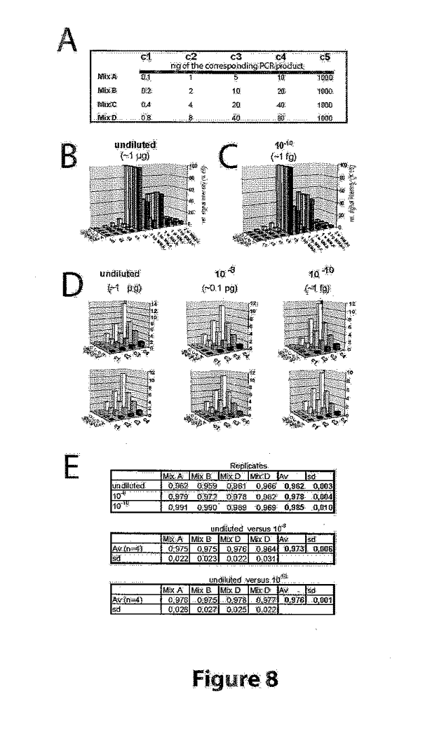

FIG. 8 depicts experiments controlling for the effects of PCR amplifications of EXT pools before microarray hybridizations.
(A) Depicted is a table listing the amounts of c1, c2, c3, c4 and c5 EXT PCR products pooled in four different samples (Mix A, B, C, D) at varying concentrations ranging from 1000 ng (c5 in all samples) to less than 1 ng of c1 in all samples (with 0.1 ng in Mix A). The corresponding c1-c5 EXT PCR products were mixed (Mix A-D) at the given concentrations and IVT labeled without or with additional PCR cycles performed with the pool input.
(B) The undiluted pools (Mix A, B, C, D; corresponding to approximately 1 μg input) were IVT labelled and subjected to microarray hybridizations without additional PCR cycles at the pool level. Signal intensities are given as relative values with the c5 signals set to 100%.
(C,D) The pools (Mix A, B, C, D) were diluted 10⁻⁸- and 10⁻¹⁰-fold (corresponding to approximately 100 and 1 fg input) and subjected to PCR amplification for 40 cycles at the pool level before IVT labelling and subjected to independent microarray hybridizations.
(B,C) Quantitative analysis of the microarray data reveals highly similar relative signal intensities comparing non-amplified (B) and PCR amplified 10⁻¹⁰-fold diluted (C) pool samples. The analyses of the c5-mismatch control EXTs corroborate the specificity of the hybridization.
(D) Plots of replicate experiments with undiluted, 10⁻⁸- and 10⁻¹⁰-fold diluted input samples hybridized to independent microarrays. Relative signal intensities are given as relative values with the c5 signals set to 100%. Highly similar results were obtained under all experimental conditions showing that PCR amplification at the pool level does not produce a bias within the samples.
(E) Table of crosswise Pearson's Correlation Coefficients (r) as a measure of the replicate performance in comparison to PCR amplification effects. The R2 values of the replicates (0.973±0.003) are not substantially different from those obtained comparing undiluted with the 10⁻⁸- and 10⁻¹⁰-fold diluted PCR amplified input samples (0.985±0.001; 0.981±0.001).

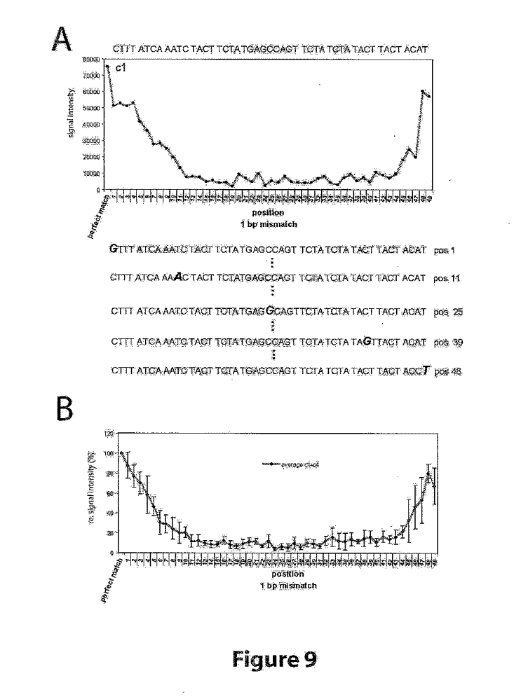

FIG. 9 depicts the specificity and hybridization performance of EXT hybridizations to single basepair scanning mismatches.
(A,B) Plotted are the signal intensity profiles of c1 (A) and the averages of c1-c4±SD (B) 1 basepair scanning mismatches covering the EXT 49 mer sequence from the 5′ to the 3′ end. The c1 perfect match sequence is depicted above the graph, selected mismatch control below. The single basepair mismatches are labeled in bold-italics letters. Central mismatches provide more discrimination power compared to those at the boundary.

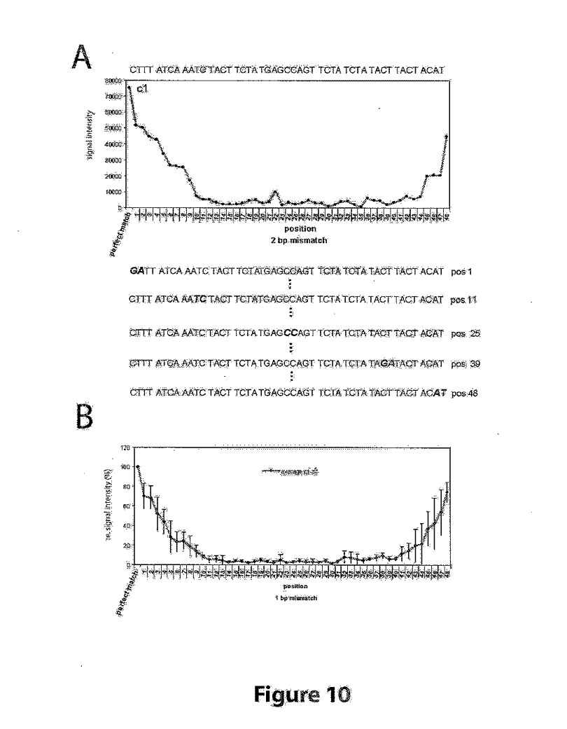

FIG. 10 depicts the specificity and hybridization performance of EXT hybridizations to two basepair scanning mismatches.
(A,B) Plotted are the signal intensity profiles of c1 (A) and the averages of c1-c4±SD (B) 2 basepair scanning mismatches covering the EXT 49 mer sequence from the 5′ to the 3′ end. The c1 perfect match sequence is depicted above the graph, selected mismatch control below. The double basepair mismatches are labeled in bold-italics letters. Central mismatches provide more discrimination power compared to those at the boundary.

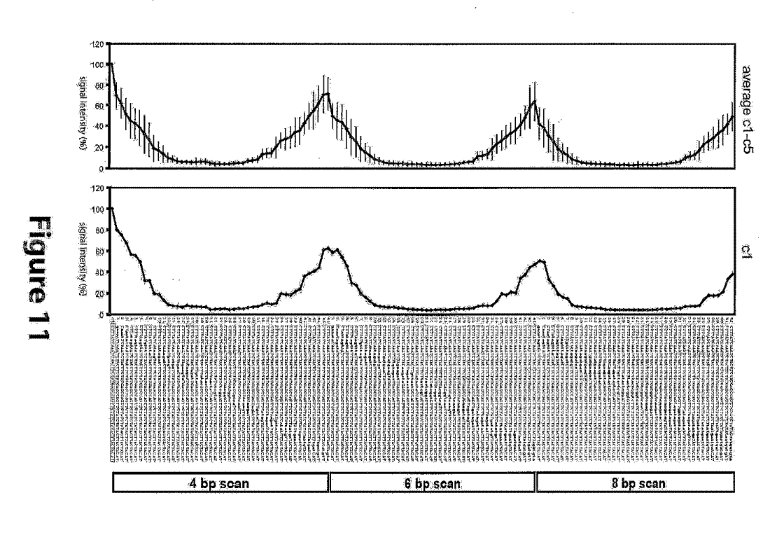

FIG. 11 depicts the cross-hybridization profiles of EXT hybridizations to 4, 6 and 8 basepair mismatches scanning the EXT 49 mer sequence from the 5′ to the 3′ end.

Plotted are the signal intensity profiles of c1-c5±SD (left) and of c1 (middle) of 4, 6, and 8 basepair scanning mismatches covering the EXT 49 mer sequence from the 5′ to the 3′ end. The c1 perfect match sequence and all corresponding mismatch are shown on the right side of the plot.

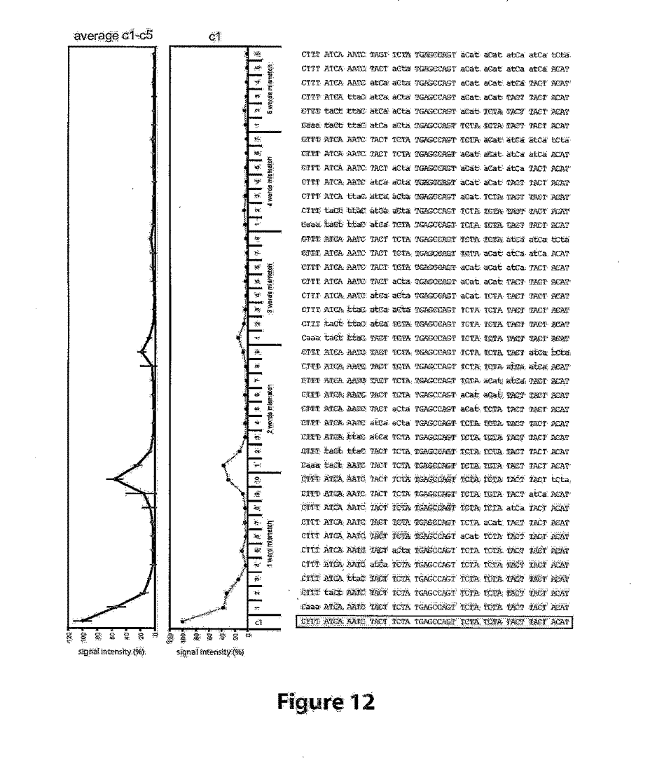

FIG. 12 depicts the cross-hybridization profiles of EXT hybridizations with word mismatches scanning the EXT 49 mer sequence from the 5′ to the 3′ end.

Plotted are the signal intensity profiles of c1-c5±SD (left) and of c1 (middle) of 1-5 word scanning mismatches covering the EXT 49 mer sequence from the 5′ to the 3′ end. The c1 perfect match sequence and all corresponding mismatch are shown an the right side of the plot.

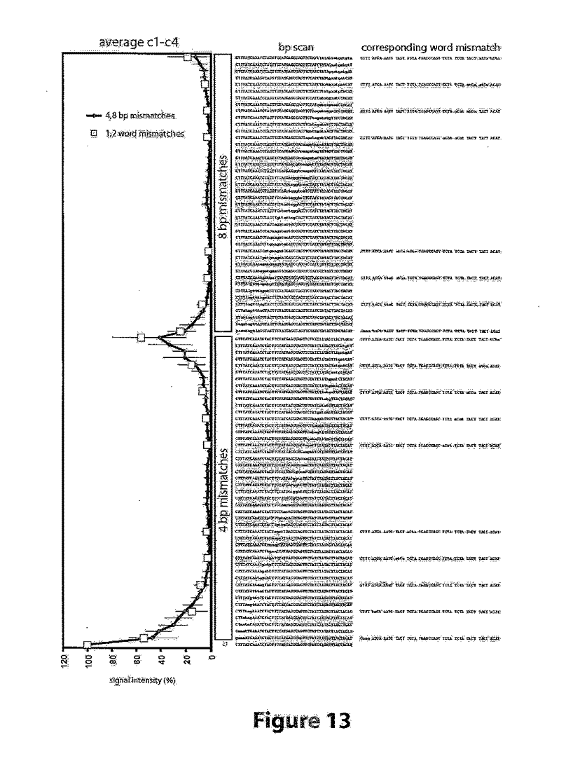

FIG. 13 depicts the cross-hybridization profiles of EXT hybridizations comparing 1 and 2 word mismatches with 4 and 8 basepair mismatches. Plotted are the signal intensity profiles of c1-c5 (left) of 4 and 8 basepair mismatch scans and 1 and 2 word mismatches (closed dots) at corresponding positions (open dots) and The c1 word mismatch sequences are shown at the left, the corresponding basepair c1-mutants on the right.

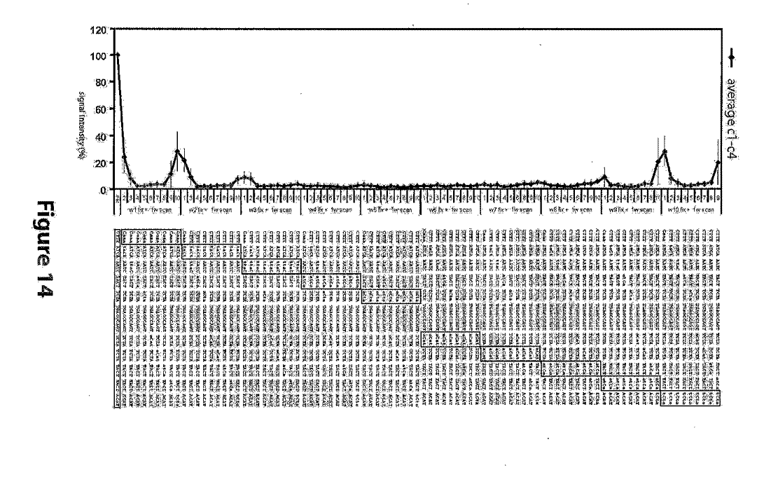

FIG. 14 depicts the cross-hybridization profiles of c1, c2, c3, c4 and c5 with one fixed and scanning word mismatches from the 5′ to the 3′ end. The signal intensities are given as averages of c1-c5 in percent (the respective perfect signal intensity was set to 100%). The c1 perfect match sequence and all corresponding mismatch are shown on the right side of the plot. Errors are given as standard deviation (SD).

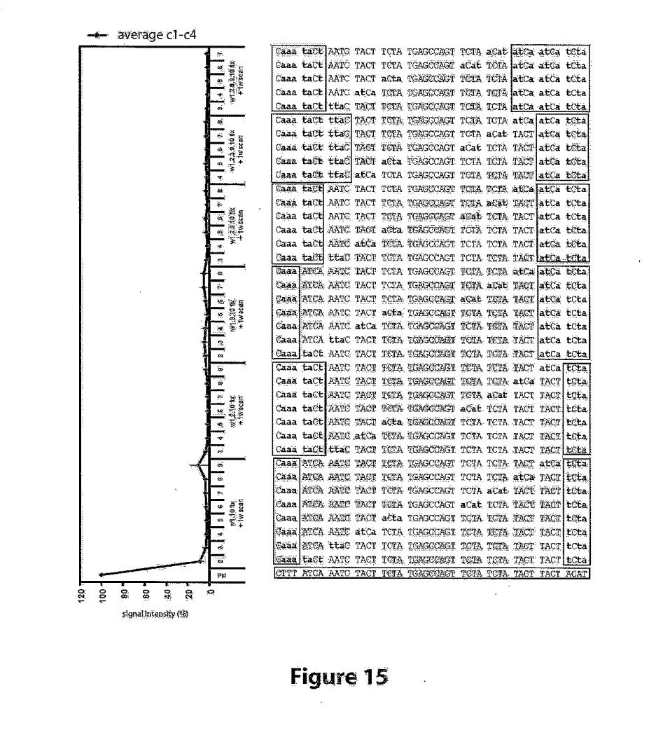

FIG. 15 depicts the cross-hybridization profiles of c1, c2, c3, c4 and c5 with 2-5 fixed and scanning word mismatches from the 5′ to the 3′ end. The signal intensities are given as averages of c1-c5 in percent (the respective perfect signal intensity was set to 100%). The ci perfect match sequence and all corresponding mismatch are shown on the right side of the plot. Errors are given as standard deviation (SD).

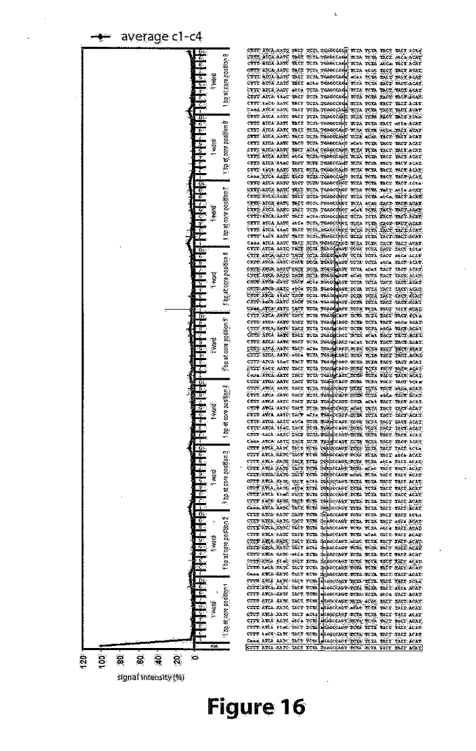

FIG. 16 depicts the cross-hybridization profiles of c1, c2, c3, c4 and c5 with combined word mismatches and single base mismatches in the core region scanning the EXT 49 mer sequence from the 5′ to the 3′ end. The signal intensities are given as averages of c1, c2, c3, c4 and c5 in percent (the respective perfect signal intensity was set to 100%). The c1 perfect match sequence and all corresponding mismatch are shown on the right side of the plot. Errors are given as standard deviation (SD).

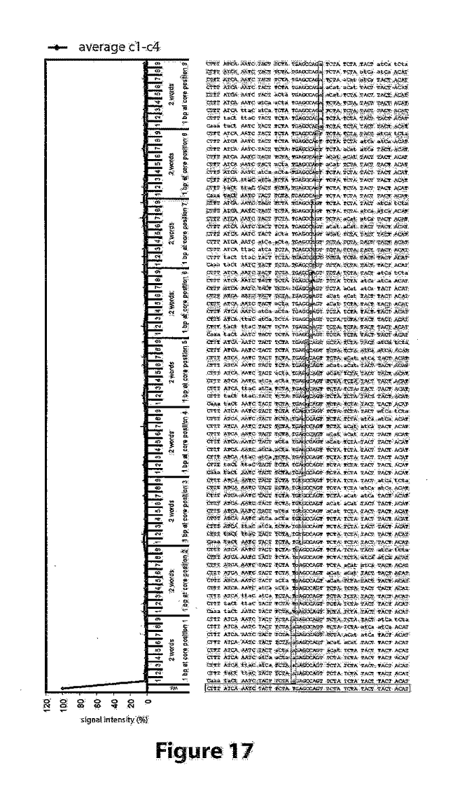

FIG. 17 depicts the cross-hybridization profiles of c1, c2, c3, c4 and c5 with combined 2 word mismatches and single base mismatches in the core region scanning the EXT 49 mer sequence from the 5′ to the 3′ end. The signal intensities are given as averages of c1, c2, c3, c4 and c5 in percent (the respective perfect signal intensity was set to 100%). The c1 perfect match sequence and all corresponding mismatch are shown on the right side of the plot. Errors are given as standard deviation (SD).

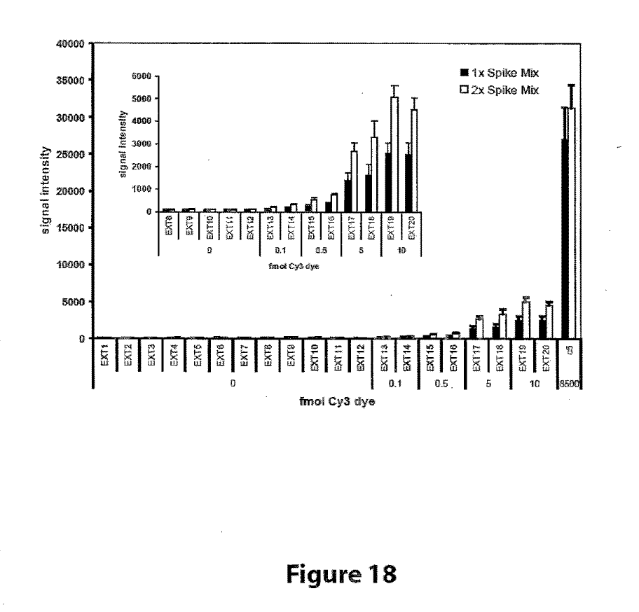

FIG. 18 depicts the performance and dynamic range of EXT microarray analyses using spike in controls. EXTs 13-20 and c5 were individually Cy3-labelled. 1× and 2× spike in mixes (comprising EXTs 13,14 at each 0.1/0.2 fmol dye, EXTs 15,16 at each 0.5/1 fmol dye, EXTs 17,18 at each 5/10 fmol dye and EXTs 19,20 at each 10/20 fmol dye) were combined with the c5 Cy3 labelled target (at high excess with 8.5 pmol) before microarray hybridization. The signal profiles show the dose-response increases in signal intensities with the EXTs spiked in at the given concentrations (inlay depicts EXTs 8-20 at reduced scale). The dynamic range spans over more than two-orders of magnitude (average background was calculated from the signals of EXTs 1-12 corresponding features with 110±5; the c5 signals were in average 29117±3722). The average fold difference between the 1× and 2× spike in mixes are slightly below the expected two-fold differences (1.84±0.19).

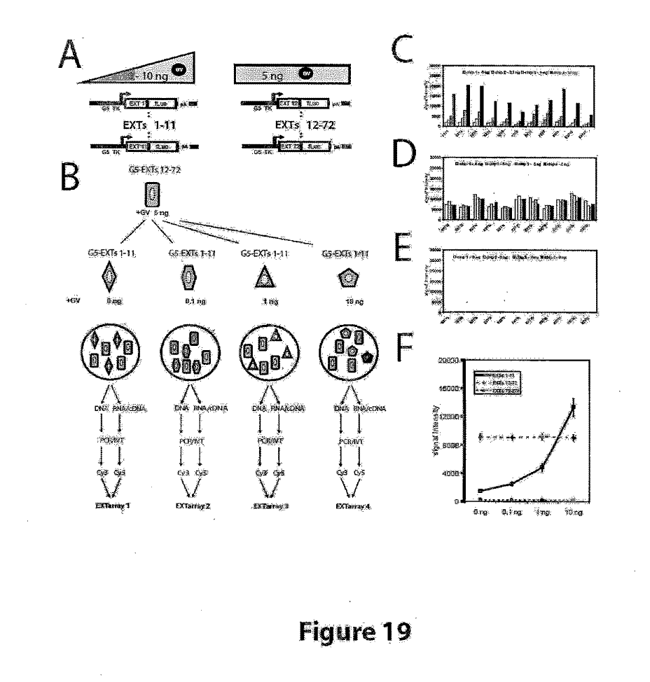

FIG. 19 depicts a dose response analysis of transcription factor activities monitored with EXTassays.
(A,B) increasing and constant amounts of the synthetic transcription factor GV (comprised of the Gal4 DNA binding domain and the transactivation domain VP16 from Herpes simplex virus) along with the corresponding GV-dependent EXT-reporter construct were transfected independently into PC12 cells. Eleven EXT-reporters (EXTs 1-11) co-transfected as a pool with increasing amounts of GV at 0, 0.1, 1 and 10 ng of GV. 71 EXT-reporters (EXTs 12-72) were transfected as a pool with a constant amount of GV (5 ng). Both cell populations were mixed prior to seeding and 48 h post-transfection, RNA was isolated, cDNA synthezised and used as template to amplify EXTs pools and products were IVT Cy5-labelled. In parallel, transfected plasmid DNA was isolated from the cells, PCR amplified and IVT Cy3-labelled. Cy3 and Cy5 labelled targets were hybridized to custom made EXTarrays harbouring corresponding complementary EXT probes.
(C-F) RNA input corresponding Cy5 signal intensities were normalized for DNA input variations using the Cy3 signal intensities. The average signals of EXTs 1-11 (EXT reporters co-transfected with increasing GV amounts as indicated) (A), of EXTs 12-72 (EXT reporters co-transfected with constant GV amount) (B) and of EXTs 73-229 (no EXT reporter transfected) (C) were plotted for EXTarrays 1 to 4. The average signals of EXTs 1-11 display a clear dose-response curve increasing proportionally with the increasing GV amounts (EXTarray 1-0 ng GV-1117±82, EXTArray 2-0.1 ng GV-1117±82, EXTArray 3-1 ng GV-1117±82, EXTarray 4-10 ng GV-1117±82) (F). The average signals of EXTs 12-72 (GV at 5 ng) remain constant across all four EXTArrays (1117±82). The average background for EXTs 73-229 is 180±30 (F).

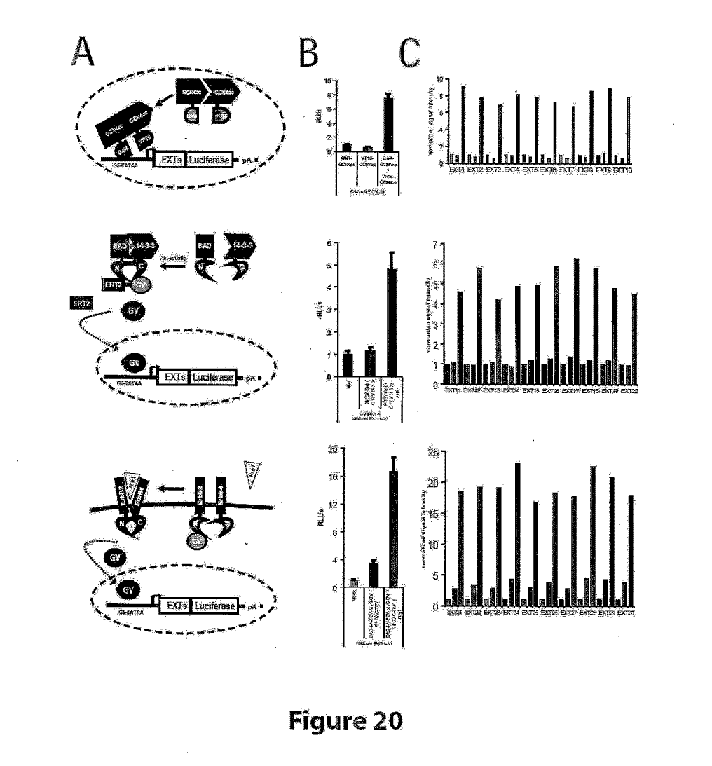

FIG. 20 depicts examples of EXTAssays measuring protein interactions in different compartments of the cell.
(A) Schematic drawings of the assays' principle. Top, mammalian two-hybrid assay monitoring the interaction of the GCN4cc homodimerizina coiled-coil domain from the yeast transcription factor GCN4 fused to Gal4 and VP16 with a pool of Gal4-dependent EXT-Luciferase reporters (G5-TATAA_{—}EXTs-Luciferase). Middle, Split-TEV assays to monitor the phosphorylation dependent Akt1-kinase induced interaction of Bad fused to the N-TEV-fragment with 14-3-3 fused to the C-TEV fragment with a second pool of Gal4-dependent EXT-Luciferase reporters (G5-TATAA_EXTs-Luciferase). Bottom, Split-TEV assays to monitor the ligand dependent dimerization of ErbB2 fused to N-TEV-tevS-GV with ErbB4 fused to C-TEV with a third pool of Gal4-dependent EXT-Luciferase reporters (G5-TATAA_EXTs-Luciferase).
(B) Luciferase assays monitoring the activity of the combined luciferase activities of 10 different EXT-Luciferase reporters (G5-Luci EXT 1-10) for each assay. All assays were performed as separate transfections in NIH3T3 cells and pooled for the luciferase measurements.
(C) Microarray-based EXTassay monitoring each EXT-reporter in a single experiment. All three experiments as depicted in (B) were pooled and analyzed simultaneously.

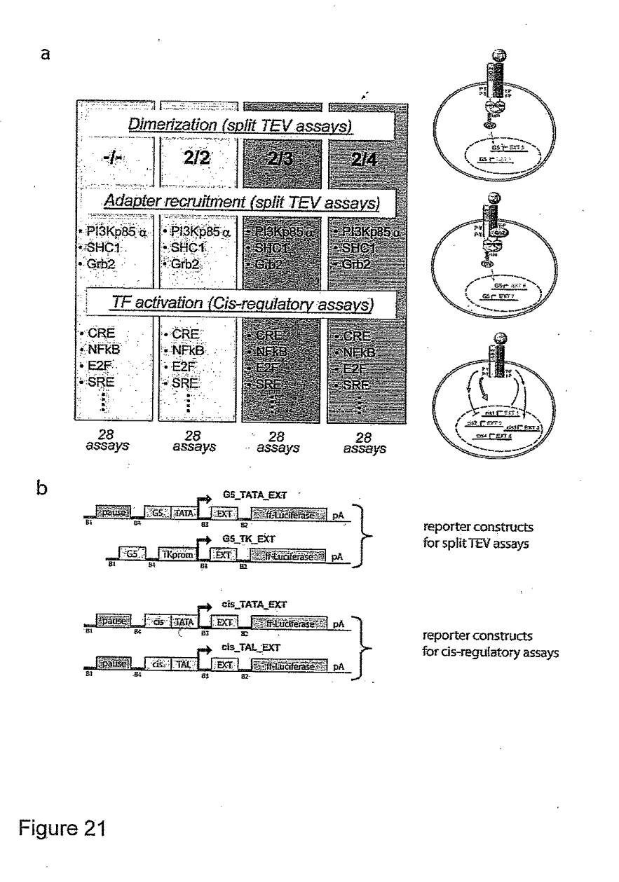

FIG. 21 describes the assay formats and reporter constructs.
(A) Summary of the assay conditions used to monitor NRG1 signalling in mock transfected PC12-OFF cells (−/−), and upon expression of ERBB2 (2/2), ERBB2 and 3 (2/3) and ERBB2 and 4 (2/4) receptors. To measure ERBB receptor dimerization, ERBB2-N-TEV-GV and ERBB2, 3 and 4 C-TEV fusion constructs were used in combination with multiple G5-EXT reporter constructs (schematic drawing of 2/3 shown on the right). Adapter recruitment to activated ERBB receptor complexes was assessed by using C-TEV fusion constructs of PI3Kp85α, SHC-1 and Grb2 in combination with the ERBB2-N-TEV-GV fusion protein which dimerizes with cotransfected ERBB2, 3 or 4 receptors to form ERBB2/2, 2/3 and 2/4 receptor complexes. A schematic drawing for Grb2 recruitment to the ERBB2/3 is shown on the right. A panel of 24 different cis-element reporter constructs was analyzed with corresponding ERBB receptor pairs.
(B) Schematic drawing of the reporter constructs used for split TEV and cis-regulatory assays. Each TEV assay was analyzed with several G5_TATA-minimal and G5_TK-promoter constructs (with 4-6 different EXTs per assay). Different cis-elements were fused to either TATA. or TAL-minimal promoters and used for cis-regulatory assays (with 2-3 different EXTs per assay).

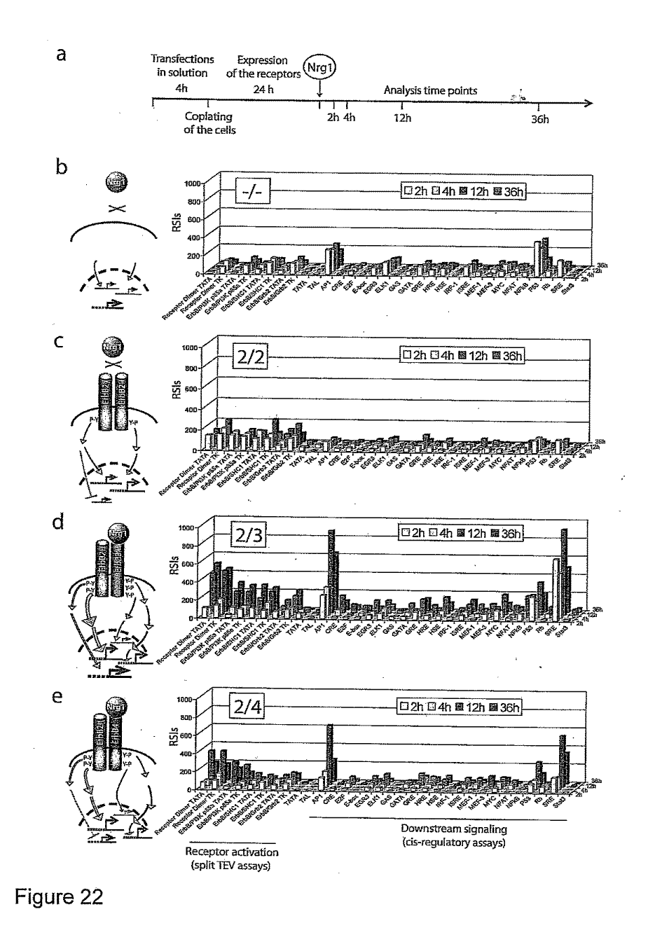

FIG. 22 shows integrated NRG-ERBB Signaling with EXTassays.
(a) PC12-OFF cells were transfected in solution with different assay components, pooled and cultured under identical experimental conditions for 24 h to allow for receptor expression. Soluble NRG1 EGF-like domain was added and cells were lysed 2, 4, 12 and 36 hours after stimulation and subjected to EXTassay analysis.
(b-e) EXTassay profiles monitoring ERBB receptor activation and cis-regulatory assays as indicated. TK, Thymidine kinase core promoter; TATA, TATA-Box minimal promoter; TAL, TATA-like minimal promoter. Signals corresponding to different split TEV interaction and cis-regulatory assays are plotted along the X-axis. Average normalized microarray intensities of corresponding EXT reporters from replicate experiments are shown on the Y-axis. Measurements performed at different time points are plotted along the Z-axis.
(b) EXTassay analysis in the absence of ERBB receptors (−/−). Split TEV and cis-regulatory EXT reporters indicate basal activities that are independent of NRG 1 stimulation. TATA-box-EXT reporters display reduced basal activities compared to the corresponding TK-core promoter EXT reporter in split TEV assays. Cis-regulatory EXT reporters indicate a specific transcription factor activity profile in PC12-OFF cells. Most prominently, p53- and AP1-reporters are activated more than 200-fold over controls.
(c) EXTassay profiles upon expression of the NRG1 binding incompetent ERBB2 receptor (2/2). The elevated levels of split TEV assays indicate ligand-independent dimerization of ERBB, whereas lower cis-regulatory reporter activities reflect altered signaling responses in PC12-OFF cells mediated by ERBB2 expression.
(d,e) NRG1 strongly induce receptor activation and downstream signaling mediated by the ERBB receptor pairs 2/3 (d) and 2/4 (e). ERBB2/3 receptor activation and downstream signaling is stronger and longer lasting compared to ERBB 2/4.

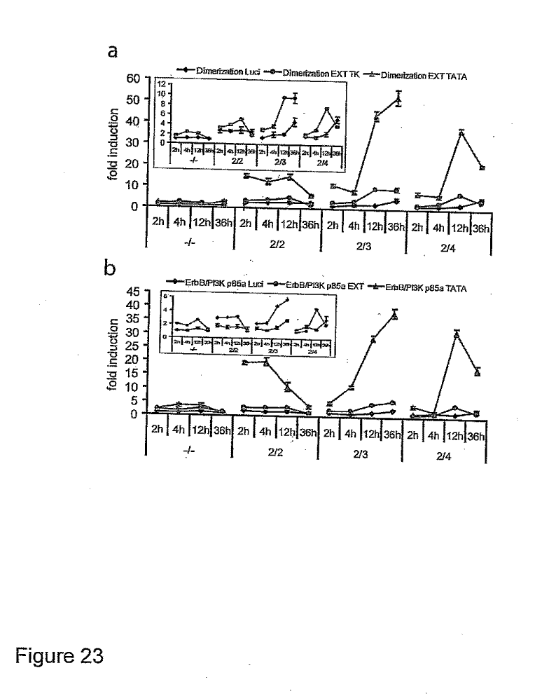

FIG. 23 shows the improved kinetic performance and sensitivity of EXT reporters compared to standard luciferase assays.
(a,b) EXT reporters and standard luciferase assays were compared to monitor NRG1-dependent ERBB receptor activation 2, 4, 12 and 36 h after stimulation (−/− no ERBB receptor expressed; 2/2=ERBB2, 2/3=ERBB2 and ERBB3, 2/4=ERBB2 and ERBB4 receptors expressed as N-TEV-GV and C-TEV fusion constructs, respectively.
(a) Split TEV dimerization assays and (b) Split TEV PI3Kp85α recruitment assays show dramatic differences in the relative fold inductions when comparing different EXT reporters (circles, G5-TK promoter constructs; triangles, G5-TATA minimal promoter constructs) with standard luciferase assays (squares) to the control situation (−/−, lowest value set to 1). EXT reporters provide a better kinetic resolution and a higher sensitivity compared to standard luciferase assays. G5-EXT-reporter constructs with the TATA-minimal promoter perform better than those carrying the TK promoter, although these also show an improved kinetic performance compared to luciferase assays (see inlay graph at a reduced scale).

The following examples illustrate the invention and are not intended to limit its scope in any way.

### EXAMPLE 1

### Describes the General Principle of Multiplexed EXTassays

The novel method described herein can replace conventional cell-based reporter assay formats with highly multiplexed reporter gene assays where EXTs replace or complement conventional reporters, we refer to this multiplexed format as EXTassays. In conventional reporter assays, each cell population represents a single assay that must be analyzed separately. 1-n assays require 1-n single measurements of the readout. With EXTassays, the pool of 1-n assays can be simultaneously analyzed. 1-n assays require one single highly multiplexed measurement (FIG. 1). The assay components may be stably integrated into the genome of the host cell or may be transiently introduced by transfection or a combination of both strategies. The cell populations may represent a mixture of distinct assays in one cell type or one assay type in different cell types or multiple assay types in different cell types. The cell populations may also represent a mixture of single or multiple assays representing sub-populations that have been treated with a defined or multiple stimuli. These treatments or stimuli may represent the addition of substances or mixtures of substances of lower or higher molecular weight such as proteins, peptides or small molecular entities.

The general principle of conventional cell-based reporter assay formats and the reporter format of EXTassays are identical but the reporter gene is replaced or complemented by a short EXpressed Tag (EXT) sequence as part of the reporter construct (FIG. 2a,b). The EXT sequence does not interfere with the functionality and performance of the reporter construct (FIG. 2c).

Principally, any reporter gene assay format can be integrated in EXTassays. Any sequence regulating transcriptional activation or repression of a given reporter construct can be analyzed with EXTs. The regulatory sequence may represent different promoter or enhancer elements found 5′ or 3′ of the reporter gene or as integral parts of the reporter. The regulatory elements may also include intronic elements or other elements modifying the structure and/or abundance of corresponding mRNAs (FIG. 3a). EXTassays can be used to monitor for the constitutive or regulated activity of transcription factors or proteins that modulate the activity of transcription factors (co-activators and co-repressors) or substances or proteins that modify transcription factor activities. These stimuli may result in altered DNA binding activities or in modified transcriptional capabilities, e.g. mediated by altered protein interactions (FIG. 3b). EXTassays can be also used to monitor for protein-protein interactions whereby e.g. split-transcription factor (TF) or a reporter gene coupled split-protease systems can be employed (FIG. 3c). The split-TF systems (generally referred to as the classical or prototypical ‘two-hybrid’ systems) are limited to interactions of soluble proteins and interactions that are stable and/or occur in the nucleus of cells. In split-protease systems, inactive protease fragments are fused to potentially interacting protein domains. Upon interaction, proteolytic activity is reconstituted and an inactivated transcription factor is released from an anchor, can translocate to the nucleus and activate reporter gene transcription (FIG. 3c). Split-protease systems are particularly suited to monitor protein interactions that occur in the cytosol and at the membrane of cells. EXTassays can be used to monitor for proteolytic activities (Protease assays) whereby a transcription factor is fused to a substrate protein and thereby inactivated (FIG. 3d). The proteolytic activity may be cell-intrinsic or exogenously added. Intrinsic proteolytic activities refer to proteins or protein complexes (proteases) that can mediate the constitutive or regulated proteolytic cleavage of an endogenous protein of any reporter protein. Exogenously added refers to the possibility that the proteases can be transferred to cells that either lack these activities or have less detectable activities. The proteases can be transferred to cells as proteins or appropriately modified RNA- or DNA-based expression systems. Constitutive or regulated protein interactions can also be monitored with ‘Protease Proximity assays’ (FIG. 3d). These or similar assays may be used to monitor for exogenous or endogenous substances or proteins that modify proteolytic events or protein interactions directly or indirectly and which may be regulated by post-translational modifications such as phosphorylation, acylation, acetylation, methylation, ubiquitination, sumoylation or combinations of these or other modifications.

### EXAMPLE 2

### Describes the Design and Properties of the EXTs and EXT Reporter Constructs

The performance of the EXTassays approach depends on the functionality of the EXT reporters to quantitatively monitor cellular events in a highly scalable manner. Thus, the EXTs are designed to yield balanced melting temperature and virtually absent intra- and intermolecular complementary regions and makes the corresponding EXTs optimally suited for any hybridization or sequence based analyses techniques. The balanced base pair composition abolishes a potential bias when using exponential amplification methods such as the polymerase chain reaction (PCR) and/or linear amplification methods such as in vitro transcription (IVT) using DNA-dependent RNA-polymerases (Sambrook and Russell, 2001). Due to the lack of guanidine residues (G) in the word alphabet, backfolding and dimer formation are also highly reduced within the EXT library. The lack of dimer formation and backfolding in combination with the balanced base pair composition makes EXTs also optimal reporter for all readout technologies such as quantitative PCR, sequencing or any method capable of quantitatively determining the abundance of a given nucleic acid in a complex mixture.

Each EXT is comprised of a variable region of 49 base and invariable 5′ and 3′ attached defined sequences (FIG. 4a). The variable region consists of several words (W) flanking a core region. Eight different 4-nucleotide words are used, each comprised of 3 Adenosine (A)/Thymidine (T) residues and one Cytosine (C) residue (5′ CTTT 3′, 5′ CAAA 3′, 5′ ACAT 3′, 5′ TCTA 3′, 5′ TACT 3′, 5′ ATCA, 3′ 5′ TTAC 3′, 5′ AATC 3′) (Brenner et al., 2000). The core region comprises nine bases of alternating A,T (W) or G,C (S) residues with three centrals G,C (S) residues (FIG. 4a). The invariable 5′ (e.g. 5′ TAGGTGACACTAT 3′ SEQ ID NO: 1) and 3′ (e.g. 5′ CCTATAGTGAGTCGT 3′ SEQ ID NO: 2) prime located regions represent short sequence stretches of similar melting temperature. EXT oligonucleotide libraries can be generated with standard deoxy-nucleic-acid (DNA) oligonucleotide synthesis chemistry. Usually, the synthesis proceeds from the 3′ to the 5′ end. The synthesis of the EXT library presented herein was therefore initiated with eight reactions and the 3′ invariable region attached to one of the eight different words. After the first synthesis cycle, the resins carrying the nucleotides were mixed and subsequently divided into eight equal portions to add the next eight words. The fifth cycle was extended with the core sequence followed by another five word cycles and the 5′ prime invariable portion (summarized in FIG. 4a).

Since the number of biologically relevant cellular events likely exceeds the number of known interactions at the level of RNA-protein, DNA-protein, protein-protein and metabolite-protein among others by several orders of magnitude. Thus, the multiplexing capacity for EXTassays needs to be high and is determined by the combinatorial complexity of the EXT library. The theoretical complexity of the 49 mer EXT library can be calculated as 8¹⁰ (10 positions with 8 words=word structure)×2⁹ (2 bases at 9 positions=core structure)=1,073,741,824×512=549,755,813,888≈5.5×10¹¹. Since some microarray platforms are restricted with respect to probe length, the combination of only 4 words (8⁴=4,096) and the core element (2⁹=512) leads to a theoretical complexity of 2,097,152≈2×10⁶. The central symmetrical core element increases the complexity compared to a pure word structure by approximately one order of magnitude. Moreover, the central and symmetrical structure allows monitoring the performance of each EXT with a few central mismatches and enhances and stabilizes the melting temperatures for hybridization approaches.

The balanced base pair composition was analyzed by computationally generating large virtual EXT libraries by random calculation and compared to cloned and sequenced EXTs as well as the profiles obtained with random 49-Nmers (with either of the four nucleotides at each position assembled in a randomized fashion). Melting temperature profiles of all EXTs were calculated using the basic formula: Tm=(wA+xT)*2+(yG+zC)*4 where w,x,y,z are the number of the bases A,T,G,C in the sequence, respectively (Marmur and Doty, 1962). The virtual and cloned EXTs display a highly narrow average TM of 61.2±0.7 and 61.2±0.8, respectively, in contrast to the broadened distribution of the, random 49-Nmers with an average TM of 70.1±3.3 (FIG. 4b). The particular EXT design also yields in an improved cross-similarity profile within large libraries as assessed by pairwise BLAST analyses of each EXT versus all EXTs in the library (Altschul et al., 1990) (FIG. 4c).

The EXT structure was designed to allow unbiased multiplexed amplification and subcloning (FIG. 5,6). Therefore, the EXT oligonucleotide library can be PCR amplified using two primers with complementary sequences directed against the invariable region of the EXTs (5′ invariable region 5′ TAGGTGACACTAT 3′ SEQ ID NO: 1, 3′ invariable region 5′ CCTATAGTGAGTCGT 3′ SEQ ID NO: 2). The primers may also included additional sequences such as T3/T7 minimal RNA polymerase promoter elements (T3-Prom 5′ GCGCGCAATTAACCCTCACTAAAGGGACAAGT 3′ SEQ ID NO: 3 T7-Prom

5′ GGCCAGTGAATTGTAATACGACTCACTATAGG 3′ SEQ ID NO: 4) decoder sequences (DECs, 5′ AGCTAGTTGCTAAGTCTGCCGAGTAG 3′ SEQ ID NO: 5, DECas 5′ TCGTACATGCATTGACTCGCGTCTAC 3′ SEQ ID NO: 6) and sites for either restriction-enzyme or recombinase mediated subcloning (R-site 1, e.g. attB3 site 5′ CAACTTTGTATAATAAAGTTG 3′ SEQ ID NO: 7 R-site 2, e.g. attB2 5′ CAGCTTTCTTGTACAAAGTGG 3′ SEQ ID NO: 8). The resulting PCR products can be mass-subloned and amplified in E. coli with standard molecular biological techniques (Sambrook and Russell, 2001). Pooled cell populations that carry one or more defined EXT reporter including all genetic components that ultimately lead to the activation of one or more transcription factors (TF) are analyzed simultaneously. Replicate pools may have been treated with a substance or different conditions which may alter the expression of EXTs. The pools of cells will be lysed at appropriate time points and genomic DNA (or plasmid DNA when transiently transfected cells are used) and total or messenger RNAs will be prepared with standard techniques. DNA or cDNA obtained via reverse transcription from RNA serves as input for PCR amplification with decoder primers directed against the DEC sequence stretches (DECs and DECas). The cDNA-derived PCR product represents a complex mixture of differentially expressed EXT reporter in the various cell pools; whereas the DNA-derived PCR products represent the input mixture of EXT constructs for normalization. The PCR products (=targets) can be analyzed by qRT-PCR, Northern Blotting, sequencing or any other method that allows the quantitative assessment of nucleic acids. In a preferred application, the PCR products can be labelled by direct or indirect incorporation of fluorescent dyes e.g. via in vitro transcription (IVT) mediated by either T7 or T3 RNA polymerases. Direct labelling refers to incorporation of fluorescent nucleotides (such as Cy3- or Cy5 conjugated uridine-tri-phopshate (UTP)); indirect labelling refers to incorporation of modified nucleotides (such as amnio-allyl-UTP) which allow for a secondary conjugation of dyes (such as Cy3- or Cy5). The labelled products (targets) can subsequently be analyzed with DNA microarrays (probes) that carry EXT complementary oligonucleotides at defined positions/spots. The relative fluorescent intensity of each spot can be used as a measure of the relative abundance or expression level of a given EXT in the corresponding target population.

### EXAMPLE 3

### Describes the Performance of EXTs in Microarray Analyses

To determine the performance and specificity of EXTs, microarray hybridization experiments with several platforms were performed. In a first set of experiments, self-spotted small scaled microarrays using codelink-slides (GE Healthcare) and amino-modified PCR products or oligonucleotides were generated according to standard procedures (FIGS. 7 and 8) (Bowtell and Sambrook, 2003).

Five randomly picked EXTs (c1-c5) and oligonucleotides highly similar to the c5 EXT sequence were used to assess the specificity and degree of cross-hybridization using this platform (FIG. 7). The analysis from two-colour experiments revealed that single word or central basepair mismatches substantially reduced the signal intensities. Nearly complete loss of cross-hybridization was achieved when either two central mismatches or one word mismatch and one central mismatches were combined (FIG. 7d,e). We also assessed the potential bias that might be introduced by amplification before microarray analysis (FIG. 8). Different pools of PCR products corresponding to the five control EXTs (c1-c5) with different concentrations over more than three orders of magnitude (between 0.1 and 1000 ng input) were analyzed with and without additional PCR cycles. Therefore, the pools were highly diluted (10⁻⁸ and 10⁻¹⁰-fold) and subsequently subjected to 40 additional cycles of PCR amplification before IVT labelling using the MEGAScript kit where 50% of the UTP was replaced by 5-(3-aminoallyl)-UTP according to the manufacturers protocols (see www.ambion.com). The RNA product of 110 bases was supplemented with 4 volumes of 100% Isopropanol and 2 volumes of buffer RLT and purified via RNeasy Mini column (Qiagen). Aminoallyl modified RNA was lyophilized and resuspended in 9 μl 2× Coupling buffer (Ambion). Mono-Reactive Cy3 or Cy5 Dye (GE Healthcare, Amersham) was resuspended in 11 μl DMSO per reaction and added to the RNA. Dye coupling was carried out for 30 min at room temperature and neutralized by 4,5 μl 4M hydroxylamine for 15 min. Labeled RNA was purified using modified RNeasy cleanup protocol as before. Concentration and labeling efficiency were determined with the help of NanoDrop-1000 spectrophotometer (Thermo Fisher Scientific). Hybridization of purified and labeled EXT samples was performed in 1× Hyb-Buffer (100 mM MES, 1 M NaCl, 20 mM EDTA, 0.01% Tween 20, 50% Formamid) at 50° C. The analysis revealed that the reproducibility of independent replicates from all samples was high (0.973±0.003, average correlation coefficient of all replicates) and that the additional PCR cycles did not compromise the dynamics of microarray data (0.985±0.001; 0.981±0.001, average correlation coefficient obtained with the undiluted compared to the 10⁻⁸- and 10⁻¹⁰-fold diluted and PCR amplified samples, respectively) (FIG. 8). EXT performance was also tested in a larger scale using custom made arrays that were obtained from either Agilent (www.agilent.com) or Nimblegen (www.nimblegen.com) and processed according to protocols given by the manufacturer. Hybridization was performed with commercial buffer systems at 65° C. with Agilent and 50° C. with Nimblegen arrays. These arrays contained systematic 5′ to 3′ scans of mismatches corresponding to the 5 control EXTs (c1-c5 see FIG. 7). Among these, 1-, 2- (FIGS. 9 and 10) and 4-, 6- and 8-basepair mismatches (FIG. 11) as well as 1-5 word mismatch scans are shown (FIG. 12). The 4 and 8 bp and the corresponding one and two word (where only the three NT residues are altered and the C remains unaltered) mismatch scans show essentially the same effect (FIG. 13). Morevover, combinations of single mismatches in the core region were combined with single and double word mismatches in the word structures (FIGS. 14-16) and more complex as well as randomly cloned EXTs (FIG. 17) were analyzed. The analysis with these microarray platforms revealed that the discrimination between similar EXTs depends strongly on the position as well as on the relative degree of identity. Full discrimination was achieved either when related EXTs at least differ in two words with one word located at positions 3-8 (FIGS. 12, 13) or in one mismatch in the core paired with one word mismatch from position 2-9 (FIG. 14). Thus, even highly related EXTs can be discriminated using self-spotted and commercially available microarray platforms. These results also underline the advantage of the EXT design for microarray analyses. Single mismatches in the core region paired with one or two word mismatches allows for full discrimination despite the known problem of cross hybridization usually observed with microarrays.

The performance and dynamic range of EXT microarray analyses was additionally challenged using spike in controls. Eight EXTs (#13-20) and c5 were individually Cy3-labelled and hybridized at increasing concentrations (FIG. 18). The input dependent increases in signal intensities with the EXTs spiked in at the given concentrations show that the dynamic range spans over more than two-orders of magnitude (average background was calculated from the signals of EXTs 1-12 corresponding features with 110±5; the c5 signals were in average 29117±3722). The average fold difference between the 1× and 2× spike in mixes are only slightly below the expected two-fold differences (1.84±0.19) (FIG. 18).

In summary, the design of EXTs allows to monitor abundance differences within complex samples with microarrays with high sensitivity and specificity. PCR mediated amplifications does not bias the analyses.

### EXAMPLE 4

### Describes the Performance of Cellular Assays Monitoring Transcription Factor Activities Using EXT Reporters

We used increasing amounts of a transcription factor and monitored the different activities with several EXT reporters (FIG. 19). Increasing and constant amounts of the synthetic transcription factor GV (comprised of the Gal4 DNA binding domain and the transactivation domain VP16 from Herpes simplex virus) were transfected independently into PC12 cells along with the corresponding GV-dependent EXT-reporter construct. Eleven EXT-reporters (EXTs 1-11) were co-transfected as a pool with increasing amounts of GV and 71 EXT-reporters (EXTs 12-72) were transfected as a pool with a constant amount of GV. 48h post-transfection, RNA was isolated, cDNA synthezised and used as template to amplify EXTs pools and products were Cy5-labelled by IVT. In parallel, transfected plasmid DNA was isolated from the cells, PCR amplified and Cy3-labelled by IVT. Cy3 and Cy5 labelled targets were hybridized to custom made EXTarrays harbouring corresponding complementary EXT probes. The average signals of EXTs 1-11 display a clear dose-response curve increasing proportionally with the increasing GV amounts The average signals of EXTs 12-72 remain constant across all four EXTarrays (FIG. 19).

### EXAMPLE 5

### Describes the Performance of Cellular Assays Monitoring Protein Interactions in Different Compartments of Living Cells with EXT Reporters

We used mammalian two-hybrid assays and Split-TEV assays to simultaneously monitor constitutive and regulated protein-protein interactions occurring in living cells with different EXT-Luciferase reporters (FIG. 20). Therefore, we transfected the different cellular sensor components of each assay independently in NIH3T3 cells and monitored both the luciferase activities in separate measurements and each individual EXT reporter in a single microarray based EXTAssay. We used Gal4-GCN4cc and VP-16-GCN4cc fusion constructs (Wehr et al., 2006) to monitor protein interactions in the nucleus with ten different Gal4-dependent EXT-Luciferase reporters (G5-Luci EXT 1-10). We used Bad-N-TEV and 14-3-3-zeta-C-TEV fusion constructs to monitor the phophorylation-dependent protein interaction in the cytosol of living cells. The interaction serves a sensor e.g. for the activity of the co-transfected or endogenously activated Akt1 kinase that phosphorylates Bad, at Ser133 (Wehr et al., 2008). We monitored the Akt1 regulated interactions using the GV2-ER and G5-Luci EXT 11-20 reporters. We used ErbB2-N-TEV-tevs-GV and ErbB4-C-TEV fusion constructs to monitor for the Neuregulin 1 ligand stimulated homodimerization of both receptor tyrosine kinase receptors (Wehr et al., 2006). As reporters we used G5-Luci EXT 21-30 reporters. Whereas standard luciferase measurement require separate experiments for each assay and reporter, microarray based EXTassays allow to monitor all assays/cellular events in parallel.

### EXAMPLE 6

### Describes the Combination of a Split-TEV Assay with EXT-Readout and the Comparison of the TEC-Readout Option with Luciferase as Reporter Gene

The signalling of different ERBB-signalling complexes was followed using a split-TEV assay either dependent on dimerization of the receptors or dependent on the recruitment of the effector phosphoinositide-3-kinase 3 (PI3Kp85). In the former case, the two subunits of the TEV-protease are linked by dimerization of the two ERBB molecules, in the latter case one subunit of TEV is linked to a subunit of ERBB and the other one is linked to PI3Kp85. In both cases the activity of TEV results in the liberation of the synthetic transcription factor GV. Constructs encoding the above mentioned proteins were introduced into cells incapable of synthesizing NRG1 and ERBB. ERBB receptor activation was induced by addition of NRG1 to the medium.

The activation of the receptor was followed by monitoring of the expression of the reporter constructs shown in FIG. 21. One group of these constructs (for the split TEV assays) was activated by the binding of liberated GV to the G5 promotor. Since ERBB signalling converges on the modulation of transcription factors, in a second group of constructs the reporters (EXTs and luciferase) were under the control of a cis-regulatory element responsive to endogenous transcription factors.

To quantitatively measure ERBB receptor signalling at different levels with EXT-assays, upstream and downstream assay components were transfected in pools of cells and the corresponding cell populations were co-plated for 24 hours prior to adding soluble NRG1 to allow for receptor expression. The cells were harvested 2 h, 4 h, 12 h and 36 h after NRG1 stimulation and plasmid DNA and RNA were isolated for subsequent EXTarray analysis. For comparative analyses, the corresponding microarray data were normalized using standard algorithms.

Next, all EXT-reporter derived signals of the control samples (−/−, no ERBB receptor) with the ERBB2/ERRB2 (2/2), ERBB2/ERBB3 (2/3) and ERBB2/ERBB4 (2/4) co-transfected samples were analyzed at all time points. EXTassay profiles of receptor activation and downstream signalling assays were plotted as bar graphs (FIG. 22b-f). The corresponding profiles of the −/− samples represent the baseline level of split TEV and cis-regulatory assays in PC12-OFF cells (FIG. 22b). Since PC12-OFF cells do not express NRG1-responsive receptors, the profile did not change significantly over time (ANOVA for time with (F 2.4; df 3) p=0.07). Split-TEV reporters displayed differences only with respect to the minimal promoter used, i.e. all TATA-box constructs showed reduced basal activities compared to TK-promoter containing reporters similar to luciferase assays (FIG. 22b). The pattern of cis-reporters indicated differential baseline activities of the corresponding TFs. Most prominently, P53 and AP1 reporter activities were elevated several-fold compared to control constructs lacking defined cis-elements (TATA, TAL).

The EXTassay profiles obtained with NRG1-binding incompetent ERBB2 receptors (2/2) revealed marked differences at the level of split TEV and cis-assays compared to the control (−/−) (FIG. 22b, c). In agreement with luciferase assays and published data (Wehr et al., 2008; Wehr, 2006), increased split TEV reporter activities likely reflect ligand-independent ERBB2 receptor dimerization and activation (FIG. 22b, c). At the level of cis-assays, ERBB2 signalling clearly induced a distinct pattern of TF activities (FIG. 22c). Most prominently, AP1 and P53 cis-reporter activities were consistently reduced throughout all time points (compared to −/−), while SRE remained largely constant. Overall, the ‘2/2’ EXTassay profile changed only slightly, yet significantly, over time (ANOVA for time with (F 3.0, fd3) p<0.03) (FIG. 22b).

The EXTassay profiles of the NRG1-responsive ERBB receptor pairs 2/3 and 2/4 revealed dramatic and highly significant time dependent changes (ANOVA for time with (F 3.0, df 3) p<2×10⁻⁹ for 2/4) (FIG. 22d, e). Whereas the ERBB2/3 heterodimer recruited PI3Kα-, SHC1-, and GRB2-phospho-adapters equally well, ERBB2/4 interacted more efficiently with PI3Kα than with SHC1 and GRB2 (FIG. 22d, e). Moreover, split TEV assays revealed kinetic differences between ERBB2/3 and ERBB2/4 receptor complexes. ERBB2/3 activation was longer lasting and more efficient compared to ERBB2/4 receptor complexes. At the level of cis-reporter activation, ERBB2/3 elicited also stronger responses than ERBB2/4, however, the patterns were distinctly different, most prominently for CRE, E-Box, NfKB, Rb and Stat3 reporter activities (FIG. 22d, e).

The receptor- and time-dependent effects were corroborated by a principle component analysis (PCA) which closely grouped all mock (−/−) and ERBB2/2 profiles. In contrast, the response patterns of ERBB2/3 (particularly those at 2 h, 12 h and 36 h) and of ERBB2/4 at 12 h were placed at distant positions.

### EXAMPLE 7

### Describes the Comparison of EXTassays and Luciferase Measurements

As a next step in the analyses, EXTassays were compared with standard luciferase assays. Thus, ERBB dimerization and phosphor-adapter recruitment were assessed with split TEV and luciferase assays as reporters for the same time points (FIG. 22a). The corresponding luciferase assays basically recapitulated the main observations that were obtained with EXTassays. However, dramatic differences with respect to kinetics and the dynamic range of the different reporter classes became apparent: TATA-EXT and TK-EXT reporters robustly detected ERBB2/3 and 2/4 activation 12 hours following NRG1 stimulation. In contrast, NRG1 effects were observed only 36 h post stimulation for luciferase assays (FIG. 23a,b). Moreover, it was found that the transient activation of ERBB2/4 was masked in luciferase assays as well as the time-dependent decline in reporter activation by ERBB2/2 (FIG. 23a,b). The improved kinetics of EXT reporters over luciferase assays may be attributed to different half-lives of mRNAs versus that of the luciferase protein. Therefore the corresponding half-lives in PC12-OFF cells were assessed. These were indeed dramatically different (t½≈5.1 h for the luciferase protein versus t½≈1.2 h for its mRNA).

### LITERATURE

Agid, Y., Buzsaki, G., Diamond, D. M., Frackowiak, R., Giedd, J., Girault, J. A., Grace, A., Lambert, J.J., Manji, H., Mayberg, H., et al. (2007). How can drug discovery for psychiatric disorders be improved? Nat Rev Drug Discov 6, 189-201.
Altschul, S. F., Gish, W., Miller, W., Myers, E. W., and Lipman, D. J. (1990). Basic local alignment search tool. J Mol Biol 215, 403-410.
Araujo, R. P., Liotta, L. A., and Petricoin, E. F. (2007). Proteins, drug targets and the mechanisms they control: the simple truth about complex networks. Nat Rev Drug Discov 6, 871-880.
Barnea, G., Strapps, W., Herrada, G., Berman, Y., Ong, J., Kloss, B., Axel, R., and Lee, K. J. (2008). The genetic design of signaling cascades to record receptor activation. Proc Natl Acad Sci USA 105, 64-69.
Bowtell, D., and Sambrook, J., eds. (2003). DNA Microarrays ‘A Molecular Cloning Manual’ (New York, Cold Spring Harbor Laboratory Press).
Brenner, S., Williams, S. R., Vermaas, E. H., Storck, T., Moon, K., McCollum, C., Mao, J. I., Luo, S., Kirchner, J. J., Eletr, S., at al. (2000). In vitro cloning of complex mixtures of DNA on microbeads: physical separation of differentially expressed cDNAs. Proc Natl Acad Sci USA 97, 1665-1670.
Butcher, E. C. (2005). Can cell systems biology rescue drug discovery? Nat Rev Drug Discov 4, 461-467.
Chanda, S. K., and Caldwell, J. S. (2003). Fulfilling the promise: drug discovery in the post-genomic era. Drug Discov Today 8, 168-174.
Cusick, M. E., Klitgord, N., Vidal, M., and Hill, D. E. (2005). Interactome: gateway into systems biology. Hum Mol Genet 14 Spec No 2, R171-181.
Drees, B. L. (1999). Progress and variations in two-hybrid and three-hybrid technologies. Curr Opin Chem Biol 3, 64-70.
Dunnwald, M., Varshaysky, A., and Johnsson, N. (1999). Detection of transient in vivo interactions between substrate and transporter during protein translocation into the endoplasmic reticulum. Mol Biol Cell 10, 329-344.
Eyckerman, S., Lemmens, I., Catteeuw, D., Verhee, A., Vandekerckhove, J., Lievens, S., and Tavernier, J. (2005). Reverse MAPPIT: screening for protein-protein interaction modifiers in mammalian cells. Nat Methods 2, 427-433.
Eyckerman, S., Verhee, A., der Heyden, J. V., Lemmens, I., Ostade, X. V., Vandekerckhove, J., and Tavernier, J. (2001). Design and application of a cytokine-receptor-based interaction trap. Nat Cell Biol 3, 1114-1119.
Fisher, J., and Henzinger, T. A. (2007). Executable cell biology. Nat Biotechnol 25, 1239-1249.
Fishman, M. C., and Porter, J. A. (2005). Pharmaceuticals: a new grammar for drug discovery. Nature 437, 491-493.
Friedman, A., and Perrimon, N. (2007). Genetic screening for signal transduction in the era of network biology. Cell 128, 225-231.
Gisler, S. M., Kittanakom, S., Fuster, D., Wong, V., Bertic, M., Radanovic, T., Hall, R. A., Murer, H., Biber, J., Markovich, D., of al. (2008). Monitoring protein-protein interactions between the mammalian integral membrane transporters and PDZ-interacting partners using a modified split-ubiquitin membrane yeast two-hybrid system. Mol Cell Proteomics 7, 1362-1377.
Hood, L., and Perlmutter, R. M. (2004). The impact of systems approaches on biological problems in drug discovery. Nat Biotechnol 22, 1215-1217.
Hultschig, C., Kreutzberger, J., Seitz, H., Konthur, Z., Bussow, K., and Lehrach, H. (2006). Recent advances of protein microarrays. Curr Opin Chem Biol 10, 4-10.
Johnsson, N., and Varshaysky, A. (1994a). Split ubiquitin as a sensor of protein interactions in vivo. Proc Natl Acad Sci USA 91, 10340-10344.
Johnsson, N., and Varshaysky, A. (1994b). Ubiquitin-assisted dissection of protein transport across membranes. EMBO J 13, 2686-2698.
Jullien, N., Goddard, I., Selmi-Ruby, S., Fina, J. L., Cremer, H., and Herman, J. P. (2007). Conditional transgenesis using Dimerizable Cre (DiCre). PLoS ONE 2, e1355.
Jullien, N., Sampieri, F., Enjalbert, A., and Herman, J. P. (2003). Regulation of Cre recombinase by ligand-induced complementation of inactive fragments. Nucleic Acids Res 31, e131.
Kerppola, T. K. (2006). Visualization of molecular interactions by fluorescence complementation. Nat Rev Mol Cell Biol 7, 449-456.
Kitano, H., Oda, K., Kimura, T., Matsuoka, Y., Csete, M., Doyle, J., and Muramatsu, M. (2004). Metabolic syndrome and robustness tradeoffs. Diabetes 53 Suppl 3, S6-S15.
Koegl, M., and Uetz, P. (2007). Improving yeast two-hybrid screening systems. Brief Fund Genomic Proteomic 6, 302-312.
Lemmens, I., Eyckerman, S., Zabeau, L., Catteeuw, D., Vertenten, E., Verschueren, K., Huylebroeck, D., Vandekerckhove, J., and Tavernier, J. (2003). Heteromeric MAPPIT: a novel strategy to study modification-dependent protein-protein interactions in mammalian cells. Nucleic Acids Res 31, e75.
Lemmens, I., Lievens, S., Eyckerman, S., and Tavernier, J. (2006). Reverse MAPPIT detects disruptors of protein-protein interactions in human cells. Nat Protoc 1, 92-97.
Levy, F., Johnsson, N., Rumenapf, T., and Varshaysky, A. (1996). Using ubiquitin to follow the metabolic fate of a protein. Proc Natl Aced Sci USA 93, 4907-4912.
Li, M.Z., and Elledge, S. J. (2005), MAGIC, an in vivo genetic method for the rapid construction of recombinant DNA molecules. Nat Genet 37, 311-319.
Marmur, J., and Doty, P. (1962). Determination of the base composition of deoxyribonucleic acid from its thermal denaturation temperature. J Mol Biol 5, 109-118.
Michnick, S. W., Ear, P. H., Manderson, E. N., Remy, I., and Stefan, E. (2007). Universal strategies in research and drug discovery based on protein-fragment complementation assays. Nat Rev Drug Discov 6, 569-582.
Ozawa, T., Takeuchi, T. M., Kaihara, A., Sato, M., and Umezawa, Y. (2001). Protein splicing-based reconstitution of split green fluorescent protein for monitoring protein-protein interactions in bacteria: improved sensitivity and reduced screening time. Anal Chem 73, 5866-5874.
Perrimon, N., Friedman, A., Mathey-Prevot, B., and Eggert, U. S. (2007). Drug-target identification in Drosophila cells: combining high-throughout RNAi and small-molecule screens. Drug Discov Today 12, 28-33.
Rual, J. F., Venkatesan, K., Hao, T., Hirozane-Kishikawa, T., Dricot, A., Li, N., Berriz, G. F., Gibbons, F. D., Dreze, M., Ayivi-Guedehoussou, N., et al. (2005). Towards a proteome-scale map of the human protein-protein interaction network. Nature 437, 1173-1178.
Sambrook, J., and Russell, D. W., eds. (2001). Molecular Cloning: a laboratory manual (3rd edition) (New York, Cold Spring Laboratory Press).
Sauer, S., Lange, B. M., Gobom, J., Nyarsik, L., Seitz, H., and Lehrach, H. (2005). Miniaturization in functional genomics and proteomics. Nat Rev Genet 6, 465-476.
Schlabach, M. R., Luo, J., Solimini, N. L., Hu, G., Xu, Q., Li, M. Z., Zhao, Z., Smogorzewska, A., Sowa, M. E., Ang, X. L., et al. (2008). Cancer proliferation gene discovery through functional genomics. Science 319, 620-624.
Shendure, J. (2008). The beginning of the end for microarrays? Nat Methods 5, 585-587.
Shendure, J. A., Porreca, G. J., and Church, G. M. (2008). Overview of DNA sequencing strategies. Curr Protoc Mol Biol Chapter 7, Unit 7 1.
Shoemaker, D. D., Lashkari, D. A., Morris, D., Mittmann, M., and Davis, R. W. (1996). Quantitative phenotypic analysis of yeast deletion mutants using a highly parallel molecular bar-coding strategy. Nat Genet 14, 450-456.
Silva, J. M., Marren, K, Parker, J. S., Silva, J., Golding, M., Schlabach, M. R., Elledge, S. J., Hannon, G. J., and Chang, K. (2008). Profiling essential genes in human mammary cells by multiplex RNAi screening. Science 319, 617-620.
Sleno, L., and Emili, A. (2008). Proteomic methods for drug target discovery. Curr Opin Chem Biol 12, 46-54.
Stagljar, I., Korostensky, C., Johnsson, N., and to Heesen, S. (1998). A genetic system based on split-ubiquitin for the analysis of interactions between membrane proteins in vivo. Proc Natl Acad Sci USA 95, 5187-5192.
Suter, B., Kittanakom, S., and Stagljar, I. (2008). Two-hybrid technologies in proteomics research. Curr Opin Biotechnol 19, 316-323.
Vidal, M., and Legrain, P. (1999). Yeast forward and reverse ‘n’-hybrid systems. Nucleic Acids Res 27, 919-929.
Wehr, M. C., Laage, R., Bolz, U., Fischer, T. M., Grunewald, S., Scheek, S., Bach, A., Nave, K. A., and Rossner, M. J. (2006). Monitoring regulated protein-protein interactions using split TEV. Nat Methods 3, 985-993.
Wehr, M. C., Reinecke, L., Botvinnik, A., and Rossner, M. J. (2008). Analysis of transient phosphorylation-dependent protein-protein interactions in living mammalian cells using split-TEV. BMC Biotechnol 8, 55.
Winzeler, E. A., Shoemaker, D. D., Astromoff, A., Liang, H., Anderson, K., Andre, B., Bangham, R., Benito, R., Boeke, J. D., Bussey, H., et al. (1999). Functional characterization of the S. cerevisiae genome by gene deletion and parallel analysis. Science 285, 901-906.
Xu, Q., Schlabach, M. R., Hannon, G. J. and Elledge, S. J. (2009) Design of 240,000 orthogonal 25 mer DNA barcode probes. Proc. Natl. Acad. Sci. USA 106, 2289-2294

1. A method for determining whether an exogenous stimulus is capable of eliciting at least one biological response in a host cell comprising the steps of:
(a) applying the said stimulus to a host cell which comprises a plurality of different polynucleotide constructs, each construct comprising (i) a unique expressed tag operatively linked to (ii) an expression control sequence whose activity can be exclusively modulated by one specific signalling pathway or cellular sensor implemented in said host cell, said signalling pathway or cellular sensor being involved in eliciting a biological response and being sensitive for the exogenous stimulus;
(b) determining the amount of at least one unique expressed tag; and
(c) comparing the amount of the at least one unique expressed tag to a suitable reference amount, whereby it is determined whether the exogenous stimulus is capable of eliciting at least one biological response in the host cell.

2. The method of claim 1, wherein said exogenous stimulus is a compound brought into contact with the said host cell.

3. The method of claim 1, wherein the reference amount is the amount which can be determined in a host cell as described in step (a) to which no exogenous stimulus has been applied.

4. The method of claim 3, wherein an amount of the at least one unique expressed tag which differs from the reference amount is indicative for a stimulus being capable of eliciting at least one biological response.

5. The method of claim 1, wherein the reference amount is the amount which can be determined in a host cell as described in step (a) to which an exogenous stimulus known to elicit at least one biological response has been applied.

6. The method of claim 5, wherein an amount of the at least one unique expressed tag which is essentially identical to the reference amount is indicative for a stimulus being capable of eliciting at least one biological response.

7. The method of claim 1, wherein the said at least one biological response is selected from the group consisting of: cell proliferation, cell differentiation, cell death, alteration of the cellular metabolism, cell migration, alteration of cell-permeability, drug resistance, herbicide resistance, fungicide resistance, and pesticide resistance.

8. The method of claim 1, wherein said specific signalling pathway or cellular sensor comprises at least one exogenously supplied signalling component.

9. The method of claim 8, wherein said at least one exogenously supplied signalling component is capable of specifically interacting with at least one endogenous component of the said specific signalling pathway or cellular sensor.

10. The method of claim 9, wherein the said at least one exogenously supplied signalling component or cellular sensor is a transcription factor which is capable of modulating the activity of the said expression control sequence.

11. A host cell comprising a plurality of different polynucleotide constructs, each construct comprising (i) a unique expressed tag operatively linked to (ii) an expression control sequence whose activity can be exclusively modulated by one specific signalling pathway or cellular sensor implemented in the said host cell, said signalling pathway being involved in eliciting a biological response and being sensitive for an exogenous stimulus.

12. The host cell of claim 11, wherein said specific signalling pathway or cellular sensor comprises at least one exogenously supplied signalling component.

13. The host cell of claim 12, wherein said at least one exogenously supplied signalling component is capable of specifically interacting with at least one endogenous component of the said specific signalling pathway.

14. The host cell of claim 12, wherein the said at least one exogenously supplied signalling component (sensor) is a transcription factor which is capable of modulating the activity of the said expression control sequence.

15. A method of using a host cell for eliciting a biological response comprising: providing a plurality of different polynucleotide constructs, each construct comprising (i) a unique expressed tag operatively linked to (ii) an expression control sequence whose activity can be exclusively modulated by one specific signalling pathway or cellular sensor implemented in the said host cell, said signalling pathway being involved in eliciting a biological response and being sensitive for an exogenous stimulus; and
determining whether an exogenous stimulus is capable of eliciting a biological response in the said host cell.

16. The method of claim 15, wherein said exogenous stimulus is a compound brought into contact with the said host cell.

17. The method of claim 15, wherein the said at least one biological response is selected from the group consisting of:
cell proliferation, cell differentiation, cell death, alteration of the cellular metabolism, cell migration, alteration of cell-permeability, drug resistance, herbicide resistance, fungicide resistance, and pesticide resistance.

18. A kit adopted for carrying out the method of claim 1.


SEQUENCE LISTING (8 sequences)

SEQ ID NO: 1 - DNA, 13 bp, Artificial Sequence
  Ext sequence
taggtgacactat

SEQ ID NO: 2 - DNA, 15 bp, Artificial Sequence
  Ext sequence
cctatagtgagtcgt

SEQ ID NO: 3 - DNA, 32 bp, artificial sequence
  Ext sequence
gcgcgcaattaaccctcactaaagggacaagt

SEQ ID NO: 4 - DNA, 32 bp, artificial sequence
  Ext sequence
ggccagtgaattgtaatacgactcactatagg

SEQ ID NO: 5 - DNA, 26 bp, artificial sequence
  Ext sequence
agctagttgctaagtctgccgagtag

SEQ ID NO: 6 - DNA, 26 bp, artificial sequence
  Ext sequence
tcgtacatgcattgactcgcgtctac

SEQ ID NO: 7 - DNA, 21 bp, artifiical sequence
caactttgtataataaagttg

SEQ ID NO: 8 - DNA, 21 bp, artificial sequence
  Ext sequence
cagctttcttgtacaaagtgg